(19) United States
(12) Patent Application Publication
(10) Pub. No.: US 2001/0049674 A1
(43) Pub. Date: Dec. 6, 2001

(54) Methods and systems for enabling efficient employment recruiting

(76) Inventors: Iqbal Talib, Centreville, VA (US); Zubair Talib, Reston, VA (US)

Correspondence Address: George T. Marcou, KILPATRICK STOCKTON LLP, Suite 800, 700 13th Street, N.W., Washington, DC, 20005, US

(21) Appl. No.: 09/820,660

(22) Filed: Mar. 30, 2001

Related U.S. Application Data
(60) Provisional application No. 60/193,263, filed on Mar. 30, 2000.

(51) Int. Cl. G06F 7/00; G06F 17/30

(52) U.S. Cl. 707/1

(57) ABSTRACT

The present invention relates to systems and methods for searching a data collection of employment information in such a manner that it is easy to search, drill down, drill-up and drill across the data collection using multiple independent hierarchical category taxonomies of the data collection.

### CROSS-REFERENCE TO RELATED APPLICATIONS

This application claims priority to and incorporates by reference in its entirety provisional application serial no. 09/193,263, filed Mar. 30, 2000 entitled “METHODS AND SYSTEMS FOR ENABLING REVENUE MODELS BASED ON THE INSTANTANEOUS PREFERENCES OF ON-LINE USERS”.

### BACKGROUND OF THE INVENTION

1. Field of the Invention

The present invention relates to systems and methods for searching a data collection of employment information in such a manner that it is easy to search, drill down, drill-up and drill across the data collection using multiple independent hierarchical category taxonomies of the data collection.

2. Description of the Related Art

The present invention is directed to systems and methods for quickly and efficiently retrieving employment information from a collection of employment data.

Many resources are presently available to assist businesses in finding suitable candidates to fill available positions. Perhaps the most common recruiting method is direct advertising by employers in the employment section of a newspaper, or in a magazine that is targeted to people having specific skills (e.g., engineers, attorneys, computer programmers, and so on). A typical employment advertisement will generally include a brief description of the available position, along with the address, telephone number, facsimile number and/or e-mail address of the employer. Applicants can apply for the advertised position by sending their resumes directly to the employer by facsimile, regular mail or e-mail. An employer will usually have a person in its employment or human resources department screen the resumes to identify the applicants best suited for the position.

Many disadvantages are inherent in this conventional recruiting method. For instance, a magazine and especially, a newspaper, has a limited amount of subscribers and generally services only a limited region. Therefore, the company's advertisement may never be seen by many qualified people outside of that region. In order to distribute the advertisement more universally, it may be necessary for the employer to run the advertisement in several newspapers or magazines, thus substantially increasing the advertising expense incurred by the company.

Furthermore, this conventional method is also very inefficient even after the resumes are received by the company. For example, because the resumes must be manually organized and screened, a person in the company's recruitment or human resources department may need to spend a significant amount of time every day performing this task. In a large corporation having many positions becoming available on a daily basis, it may be necessary for several people to devote most of their time to organizing and screening applicants' resumes. Furthermore, because a large amount of resumes may be received, the task of organizing and screening those resumes may be particularly onerous and thus, a certain resume may be overlooked or mishandled. As a result, a candidate who is well suited for a position may never be considered.

In an attempt to increase the scope of their advertising, some companies have begun using computer networks, such as the Internet, to post employment opportunities. For instance, a company may set up its own “home page” on the World Wide Web (the “Web”) on which various job openings can be posted. Anyone who subscribes to the Internet can thus access or “log on” to that company's home page, determine which positions at that company are available, and send a resume to the company via regular mail, facsimile or e-mail.

Although a home page can be a useful tool in enabling a company to expand its advertising capabilities, a home page provides no mechanism for organizing or screening resumes that are received. The received resumes still must be organized and screened by a person in the company's human resources department in the traditional manner. Hence, the possibility still exists that a resume will be overlooked or mishandled.

Furthermore, in order for an applicant to see the company's advertisement, the applicant must be aware that the company exists and has a home page on the Web. Hence, if the applicant has never heard of the company, the applicant would not be aware that company has a home page. Many highly qualified candidates therefore may overlook a company's advertisement because they simply are not aware that the company exists.

Several advertisement agencies have recognized these potential shortcomings and have developed “career bulletin boards” on the Web. A career bulletin board, such as CareerMosaic, MonsterBoard, and the like, is an electronic bulletin board on which messages can be “posted” as on a conventional bulletin board. A career bulletin board is advantageous because it provides a single location at which many companies can post employment opportunities. A job seeker can log onto the bulletin board to peruse the posted available positions. However, several problems are inherent with career bulletin boards.

For example, if a company wants a job seeker to see complete descriptions of their job openings, the company must send those complete descriptions directly to the bulletin board provider. The computer at the site of the bulletin board provider must store all of the company's information and thus, must have access to a large amount of memory.

Furthermore, the computer must be capable of continuously accessing that information to display it on the bulletin board. These accessing and displaying operations, which involve the handling of large amounts of data, may slow the computer's operation significantly. As a consequence, if many job seekers are accessing the bulletin board at the same time, the computer may be incapable of handling this high level of activity. Hence, additional job seekers may be unable to access the bulletin board at that time, or job seekers who are already logged onto the bulletin board may experience very slow service. Also, if a failure occurs with the computer, the entire bulletin board will become unavailable and thus, every job posting will become unavailable.

Additionally, bulletin boards are typically set up so that a job seeker submits a resume directly to the bulletin board provider. The resume is stored in a central repository along with all of the other resumes, and must be forwarded to the company to which the job seeker is applying for employment. This type of arrangement decreases the confidentiality of the resumes, because they are handled by the bulletin board provider instead of only by personnel at the company. Also, this type of arrangement decreases the company's confidentiality, since a complete job description is sent to the bulletin board provider. Furthermore, once the resumes are received by the company, they still must be manually organized and screened. In addition, if a company updates its listing of job descriptions, the updated list must be sent to every bulletin board to which the company subscribes.

It is further noted that the direct advertising methods discussed above require that a job seeker monitor the advertisements on a regular basis in order to ascertain whether a specific position is available. Hence, instead of relying on advertisements, an employer or job seeker may use a professional recruiter to find suitable candidates for available positions and vice-versa. However, the efforts of professional recruiters are limited by the resources available to them.

For example, if a recruiter has been hired by an employer to find suitable candidates for an available position, the recruiter must undertake efforts such as “cold calling” suitable candidates employed by other companies, networking with other recruiters to obtain names of potential candidates, and the like. Conversely, if a recruiter has been hired by a job seeker to find a suitable position, the recruiter may need to undertake similar efforts to locate such a position. Hence, it is likely that a recruiter will overlook available positions and suitable candidates. Furthermore, since recruiters charge a substantial fee for their services, many companies and job seekers are reluctant to use a recruiter and incur such expense.

In order to assist companies in facilitating their recruiting efforts, several software companies have developed resume screening programs which can be configured to screen a collection of resumes for the most qualified candidates. Resumes that are received by an employer that uses this software are first scanned into a computer and stored. The computer running the resume screening software can then be controlled to search those resumes for various attributes, such as college degrees, prior experience, special qualifications, and the like. The computer will then provide a list of the most qualified candidates out of the entire collection of resumes. This computerized screening and sorting method allows human resource personnel to devote more time to other tasks.

However, known resume screening software does not assist employers in advertising available positions. Although the resume screening software is useful once a resume has been received by the company, it provides no advantage in enabling the company to solicit resumes from the most qualified candidates. A company must still use either the conventional methods of advertising (e.g., newspaper, magazines, professional recruiter, etc.) or a career bulletin board in order to solicit resumes. Hence, the drawbacks associated with those types of advertising methods have not been resolved.

Therefore, a continuing need exists for a system which will maximize the scope of a company's advertising efforts while also providing a reasonably secure and efficient manner of forwarding resumes to the company and enabling the company to efficiently screen and categorize the resumes received. Additionally, a continuing need exists to assist a job seeker in locating available positions quickly and effectively.

FIG. 1 is a visual representation of a database 1. This database 1 is made up of a plurality of records 2. Each record may consist of a single character, a string of characters, a plurality of strings of characters, an image, an audio file or any combination of the preceding. The size of the database 1 can be described by making reference to the number of records 2 within it. Large databases may contain millions of records.

The task of a search engine is to provide the user with a list of links to records that the search engine calculates are likely to hold information desirable to the user. This list is compounded by using a search term or query 3. One method of compounding this list is a full-text algorithm. A “full-text” search algorithm identifies records that contain key term(s) in each and every record. In other words, the search process effectively identifies records such as record 2 that contain the search term 3. When the search is completed, a numerical count of the total number of records containing the search term(s) is compiled and displayed along with a list of links to those records to allow the user to view the records. That is, the number of matches, e.g., “2,000 matches,” links and descriptions of the first few matching records are displayed to the user. The user reviews the number of matches and the provided descriptions of some of the matched records and either decides to try a different search in an attempt to shrink the number of matches or selects one listed link to access a particular record.

One problem with these types of search engines is the often-large number of matches returned to the user. If a user enters the search term “tax,” he/she may receive over 1 million matches. Almost no user will wade through all 1 million records looking for the best or specific record that he/she needs.

If the user edits the search term(s), he/she may pare the number of matches down from 1 million to 200,000, but this number of matches is still too large for a user to view and use to make an effective decision. The user may then try to re-edit the search terms in an iterative process until the number of matches is manageable. However, this iterative process of re-editing search terms is time consuming and may frustrate the user before he/she receives the desired data.

In an effort to reduce this frustration, search engines were developed that categorize the records and provide the categories to the user so that he/she may reduce the number of records before executing a search using search term(s).

FIG. 2 shows some records 205, 210 and 215 from database 1. These records are categorized. The exemplary categories 250 shown are “Virginia,” “Fairfax,” “McLean,” “Reston,” and “Chantilly.” These categories 250 relate to state, county, and city.

One method of categorizing records is to apply tags to each record. For example, if a record contains data which relates to a certain geographic area such as a state, then that record is 20 tagged with a unique tag identifying its relationship to that state. Other records that do not contain data related to that geographic area are not tagged with that unique tag. These tags are later used to identify and retrieve records containing data related to certain geographic areas. As a further example, if a record contains the word “Virginia,” then that record is tagged with a tag called “VA.”

The categorized records 205, 210 and 215 are tagged with a single taxonomy because all of the categories 250 represent a class or subset of the “Location” taxonomy. Assuming all of the records within database 1 are categorized, database 1 can be referred to as a “single-taxonomy, categorized database.”

Given these definitions, it is clear that a taxonomy is a hierarchical organization of categories and the various taxonomies and categories inherent to a database can be used to organize the records in a database. This organization of the records, in turn, makes it easier to search for, retrieve, and display records containing specific data. In other words, a user may use the taxonomies and categories to search database 1 if the records in database 1 are properly tagged.

Typically, taxonomies and categories are selected from among those characteristics and attributes which a user would intuitively think of to launch a search. For instance, a user attempting to find a physician in McLean, Va., using a Web search engine would formulate a search based on certain intuitive characteristics, one being the “location” of all of the physicians in database 1. This intuitive characteristic becomes a taxonomy. This search can be narrowed by using attributes, such as “state,” “county” and “city.” These intuitive attributes are categories within the taxonomy.

One problem with most conventional search tools based on categories is that they only provide the user with a single taxonomy. For example, assume that a user searches using a taxonomy called “Location” and a category called “Virginia” to identify all of the pharmacists in Virginia. Suppose now, however, the user wishes to identify only those pharmacists who are “retail” pharmacists. For a single-taxonomy, categorized search this means launching a new search because “retail” is neither an attribute nor a characteristic related to “location.” Instead, “retail” is independent of location and is related to a different taxonomy, such as “Products and Services.”

To try to alleviate this problem, many single-taxonomy, categorized search engines allow Boolean operations. Thus, if the user discovers that there are 10,000 pharmacists in Virginia, he/she may further refine this search by searching for the word “retail.” Thus, the user edits the search to be “Pharmacists” AND “Retail” in the category “Virginia.” This type of search modification is only marginally effective, for several reasons. First, the use of a Boolean search at this point usually entails the initiation of a new search. Second, the search engine, because it does not provide a taxonomy, cannot suggest terms for narrowing the search to the desired data, which requires the user to be clear about and know the Boolean query terms in advance.

Another problem with finding information in product catalog databases is that the user is often asked to choose multiple parameter attributes that end up defining a product that doesn't exist. For example, a user may be interested in finding a used automobile satisfying the following criteria: greater than 200 horsepower, less than 10,000 miles, greater than 50 miles per gallon fuel efficiency, and a price less than $10,000. After spending time naming all these parameters, the search may reveal that no product contains all these attributes. An alternative embodiment in the present invention is to have the user first specify the one or two attributes that are most important and then present the user only with valid, non-zero categories regarding products in the catalog. For example, in a “step search” process, the user might consider the attribute of in excess of 200 horsepower as the most important. The system would then inform the user how many cars there are that contain this attribute and allow the user to view these results from a variety of perspectives, like by price (e.g. 10 between $10,000-$20,000, 50 between $20,000-30,000 and 100 in excess of $30,000); by fuel efficiency (e.g. 80 between 10-20 mpg, 60 between 20-25 mpg and 20 in excess of 25 mpg); or by mileage (e.g. 50 between 0-20,000 miles, 50 between 20,000-50,000 miles and 60 in excess of 50,000 miles).

In an attempt to address data searching of ever increasing databases, many techniques have been developed. For example, U.S. Pat. No. 5,675,786 relates to accessing data held in large computer databases by sampling the initial result of a query of the database. Sampling of the initial result is achieved by setting a sampling rate which corresponds to the intended ratio at which the data records of the initial result are to be sampled. The sampling result is substantially smaller than the initial query result and is thus easier to analyze statistically. While this method decreases the amount of data sent as a result of the query to the end user, it still results in an initial search of what could be a massive database. Further, dependent upon the sampling rate, sampling may result in a reduction in the accuracy of the information sent to the end user and may thus not provide the intended result.

Another example, U.S. Pat. No. 5,642,502, relates to a method and system for searching and retrieving documents in a database. A first search and retrieval result is compiled on the basis of a query. Each word in both the query and the search result are given a weighted value, and then combined to produce a similarity value for each document. Each document is ranked according to the similarity value and the end user chooses documents from the ranking. On the basis of the documents chosen from the ranking, the original query is updated in a second search and a second group of documents is produced. The second group of documents is supposed to have the more relevant documents of the query closer to the top of the list. While more relevant documents may be found as a result of the second search, the patent does not address the problems associated with the searching of a large database and, in fact, might only compound them. Additionally, the patent does not return categorized search results complete with counts of the number of records associated with those categories. Additionally, the reference does not disclose the return categorized search results complete with counts of the number of records associated with those categories.

Yet another example, U.S. Pat. No. 5,265,244 relates to a method and apparatus for data access using a particular data structure. The structure has a plurality of data nodes, each for storing data, and a plurality of access nodes, each for pointing to another access node or a data node. Information, of a statistical nature, is associated with a subset of the access nodes and data nodes in which the statistical information is stored. Thus statistical information can be retrieved using statistical queries which isolate the subset of the access nodes and data nodes which contain the statistical information. While the patent may save time in terms of access to the statistical information, user access to the actual data records requires further procedures.

Further, U.S. Pat. No. 5,930,474 discloses a search engine configured to search geographically and topically, wherein the search engine is configurable to search for user-entered topics within a hierarchically specified geographic area. This system makes use of a static index of results for each taxonomy. Because this system does not produce dynamic search results, it precludes the ability to switch among multiple taxonomies. The system is also not text searchable at any time during a drill-down. The system also doesn't include counts of records with category results.

U.S. Pat. No. 6,012,055 discloses a search system comprising multiple navigators switchable by tabs in the GUI, having the ability to cross-reference amongst said navigators. This is just a method for accessing different information sources, not a method for text-searching. Further, it does not offer user-categorized search results with counts.

U.S. Pat. No. 5,682,525 discloses an online directory, having the capability to display an advertisement incorporated within a map display, wherein the said map has indicia for points of interests selected by a user from a drop down menu. This invention describes a technique for identifying targeted advertising based on categories selected within a hierarchical taxonomy. This invention does not consider cross-sections of categories across multiple taxonomies, i.e. location, business type, and products/services. Nor does this invention consider the addition of keyword searches as a further limiting item for identifying targeted advertising.

U.S. Pat. No. 6,078,916 discloses a search engine which displays an advertising banner having a keyword associated therewith, wherein the keyword is related to a user-entered search topic. This invention discloses a method for organizing information based on the statistics and heuristical information derived from a user's behavior.

Megaspider, a meta-search engine, has a web directory with hierarchically arranged geographic regions, having subcategories therein for topics, said directory being searchable within a geographic area or within a topic. However, MegaSpider's search technology employs a static hierarchical drill-down and cannot execute a full-text search and return categorized search results with counts. Additionally, this system only has one hierarchical taxonomy and cannot switch between multiple taxonomies, nor yield categorized search results with counts when searching.

U.S. Pat. No. 5,832,497 discloses a system which enables users to search for jobs by geographical location and specialty. While this invention does discuss an iterative method for finding information in a multi-dimensional database, it does not consider categorized search results with counts (i.e. the ability to conduct a field or free-text search and have the results be returned by one or many sets of hierarchically organized categories with counts of the number of records associated with each of those categories), nor the ability to switch among taxonomies.

However, none of these conventional systems provide users with a multiple-taxonomy, multiple category search engine that allows users to search for records, where the user is allowed to toggle among the multiple taxonomies as an aid to locating desired records without constraints.

Traditional search engines are also not generally compatible with small screens such as on cell phones, pagers and personal digital assistants (PDAs) and palm-held devices. This is because these traditional search engines deliver long laundry lists of record hits that the user is required to scroll through. Transmitting these long laundry lists requires substantial bandwidth. Generally, an increase in use of bandwidth by a user translates into an increase in cost. Additionally, these small screens only allow the display of one or two record hits. This makes it cumbersome for the user to compare the record hits to determine which one best suits his/her requirements. The present invention, in contrast, provides a mechanism for toggling among taxonomies so as to narrow the display such that it may fit onto a small screen.

Additionally, traditional search engines do not provide ways to effectively relate banner advertising to the user viewing the search results. As an example, suppose a user enters the search term “Virginia” AND “Pharmacists.” The search engine may place a banner ad on the results Web page to a pharmacy in Virginia that is hundreds of miles away from the user. This ad placement is not valuable to the user or the merchant. Thus, there is also a need to determine what a user is searching for in a more specific manner so that banner advertising may be provided to that user where the advertising is more closely related to what the user is searching for.

### SUMMARY OF THE INVENTION

The present invention overcomes the shortcomings identified above. More specifically, the present invention is a multi-taxonomy, multi-category search tool that allows a user to “navigate” through a database using any of the taxonomies at any time.

In addition, the present invention overcomes the identified shortcomings of other search engines when small screen devices are employed to display search results. More specifically, the present invention transmits and displays categories for users to select from rather than providing users with long laundry lists of record hits.

Through the presentation of categorized search results, the present invention allows an enormous database to be represented in a very small footprint, which is ideal for wireless devices.

Further, the present invention provides a mechanism for “slicing-and-dicing” the information in a database, thus, allowing the creation of personalized or customized data collections of information.

The present invention further provides such advantages by means of a system for searching a collection of employment and job data, said system comprising: an organizer configured to receive search requests, said organizer comprising: a collection of employment and job data having at least two entries; wherein the collection of employment and job data is organized into at least two taxonomies; wherein each of the at least two taxonomies is associated with at least two categories; wherein the entries correspond to at least one of the at least two taxonomies and also correspond to at least one of the at least two categories; and a search engine in communication with the collection of employment and job data, wherein said search engine is configured to search based on the at least two taxonomies and based on the at least two categories, wherein the search engine returns, in response to a search request identifying at least a first taxonomy of the at least two taxonomies, a list of the categories associated with the at least first identified taxonomy, along with the number of entries associated with each of the categories associated with the at least first identified taxonomy.

The above advantages are further provided through the present invention, which is a system for searching a collection of employment and job data, said system comprising: means for networking a plurality of computers; and means for organizing executing in said computer network and configured to receive search requests from any one of said plurality of computers, said means for organizing comprising: a collection of employment and job data having at least two entries; wherein the collection of employment and job data is organized into at least two taxonomies; wherein each of the at least two taxonomies is associated with at least two categories; wherein the entries correspond to at least one of the at least two taxonomies and also correspond to at least one of the at least two categories; and means for searching in communication with the collection of employment and job data, wherein said means for searching is configured to search based on the at least two taxonomies and based on the at least two categories, wherein the means for searching returns, in response to a search request identifying one of the at least two taxonomies, a list of the categories associated with the identified taxonomy, along with the number of entries associated with each of the categories associated with the identified taxonomy.

The above-identified advantages are further provided through a system for searching a collection of employment and job data, said system comprising: means for networking a plurality of computers; and means for organizing executing in said computer network and configured to receive search requests from any one of said plurality of computers, said means for organizing comprising: a collection of employment and job data having at least two entries; wherein the collection of employment and job data is organized into at least two taxonomies; wherein each of the at least two taxonomies is associated with at least two categories; wherein the entries correspond to at least one of the at least two taxonomies and also correspond to at least one of the at least two categories; and means for searching in communication with the collection of employment and job data, wherein said means for searching is configured to search based on the at least two taxonomies and based on the at least two categories, wherein the means for searching returns, in response to a search request identifying one of the at least two taxonomies, a list of the categories associated with the identified taxonomy, along with the number of entries associated with each of the categories associated with the identified taxonomy.

Additionally, the above-identified advantages are provided through an article of manufacture comprising: a computer usable medium having computer program code means embodied thereon for searching a collection of employment and job data, the computer readable program code means in said article of manufacture comprising: computer readable program code means for communicating a search request to a search engine, the search engine being in communication with a collection of employment and job data; wherein the collection of employment and job data has at least two entries; wherein the collection of employment and job data is organized into at least two taxonomies; wherein each of the at least two taxonomies is associated with at least two categories; wherein the at least two entries correspond to at least one of the at least two taxonomies and also correspond to at least one of the at least two categories; computer readable program code means for querying of the collection of employment and job data by the search engine based on the communicated search request; wherein a communicated search request identifies at least one of the at least two taxonomies; and computer readable program code means for returning of a list of the categories associated with the at least one identified taxonomy, along with the number of entries associated with each of the categories associated with the at least one identified taxonomy as a response to the querying of the collection of employment and job data.

When potential users navigate a database powered by the present search technology, they are greeted with an “aerial” view of the entire data collection. The invention replicates real-world customer service on the Internet by shaping itself to the needs, priorities, and discretion of the user. Users thus have the ability to intuitively navigate through huge amounts of information by using keywords and categories in conjunction with the different taxonomies of the data collection. These navigation features are a significant aspect of this data collection search that differentiates it from conventional search technology.

When a user knows what he/she is looking for, the invention quickly uncovers the right information without forcing the user to go through numerous irrelevant search results. The real power of the search technology comes when users do not know or are only vaguely familiar with what they want. In these instances, where a user needs to browse through all or part of the data listings, keyword searches with categorized search results (from different taxonomies) will facilitate easy navigation by providing the user with context and scope relating to the search results and by giving a user the information he/she needs to find the products, services and information they required.

The present invention provides users with an aerial view of the data collection at all times during a search. Users remain aware of where they stand in their search and how many records potentially satisfy their query. More importantly, users receive categorized search results that provide summary information on the records in the data collection that remain within the parameters of a search.

Users of the present invention can look for information using keywords they feel will help them refine their search. The system will locate every record in the data collection that contains that particular word or phrase and instantly return all the data categories (at the category level of the search as then being conducted) that have associated records. The search results indicate how many records exist within each applicable category, and allow users to easily hone down on the specific segment of the data collection he/she is interested in and, more importantly, to disregard all other irrelevant information.

For example, if a user enters the search term “wheel alignment,” the system would search all the records in the data collection that contained the term “wheel alignment.” Rather than returning a long list of 1,701 search results that satisfy the user's query, the present invention provides the user with the categories that are associated with the remaining records and indicates how many records are associated with each category. This functionality assists the user to further refine his/her search and disregard the irrelevant information.

These searched data collections provide users with summary information (categorized search results) about the data collection being searched. Users need not use pull-down menus or fill in any “required” fields to construct the parameters of their search (zip code, city, business category, etc.). Rather, search results display the valid categories and indicate how many records are associated with each applicable category. Users are thus presented with the available options in the data collection (through a dynamic aisle and shelf structure) and can drill down through hierarchically organized data collection information or switch among taxonomies to find what they require.

If a user within the Healthcare Providers Category clicks on “Physician,” the present invention proceeds down the hierarchy and presents the user with the next level categories and show the physicians by area of specialization. If a user clicks on the “Physician” tab, the present invention will instantly reorganize all the electronic records that remain within the parameters of the search (regardless of number) and present the same information categorized by a “Physician” taxonomy of the electronic product catalog. Switching among taxonomies is possible at any point in the search process. Further, certain taxonomies are designated as “step search” taxonomies are presented to the user as preferred options when the user has drilled down to a specific category in the “Physician” taxonomy.

In instances where data collection information can be associated with more than one independent category structure (e.g., yellow page category headings and geographic location), users of the present invention can switch taxonomies of the data collection at any time during the search process and look at information from different perspectives, although in one embodiment of the present invention “step search” taxonomies are not introduced until the user has drilled down to a specific category in the “Product Type” taxonomy. For example, the “Style,” “Color,” and “Size” taxonomies are “step search” taxonomies because they are not presented as options to the user until the user has selected a clothing category in the “Product Type” taxonomy. Likewise, taxonomies for “Processor Speed,” “Hard Disk Size,” “Monitor Size,” and “Memory Amount” are not presented as options to the user until the user has selected a computer category in the “Product Type” taxonomy.

Step search taxonomies preferably apply to some products in the electronic catalog, while 20 traditional taxonomies, such as “Price,” “Promotions” and “Brands”, apply to all products in the electronic catalog. A “Monitor Size” taxonomy is obviously inapplicable to a user searching for clothing products as much as a “Style” taxonomy is inapplicable to a user searching for a computer. A “Price” taxonomy, however, would apply to a user searching for any product.

The data collections replicate existing business paradigms from the physical world on to the Internet landscape. The dynamic aisle and shelf structure and humanistic interface can help companies retain current users, acquire new customers, and maximize the value of their online traffic. This functionality also spawns new and innovative revenue and business models that help monetize eyeballs and turn Internet browsers into buyers.

It is understood that the Internet provides an unprecedented opportunity to collect and analyze data. The present invention also improves the collection of user data because users navigate through data collection information by drilling down hierarchically organized categories using their mouse or wireless keypad. Each time the user clicks down a category or switches his/her taxonomy to a different category structure, there is the opportunity to accumulate real-time marketing information that can be responded to interactively or later collected, analyzed and used to derive revenues. Cumulatively, this additional information about customers (demographics, decision patterns, trends, preferences) is more meaningful and can help manage customer relations and product development.

### BRIEF DESCRIPTION OF THE DRAWINGS

FIG. 1 is a simplified diagram of a database;

FIG. 2 is a simplified view of various records;

FIG. 3 is a system in accordance with a preferred embodiment of the present invention;

FIGS. 4-6 are screen shots a user would see when using an embodiment of the present invention as applied to a database of job listings;

FIG. 7 is a representation of how a query interacts with indices and how those indices relate to records in a database according to an embodiment of the present invention;

FIGS. 8-10 represent process steps a user would go through to drill down to a set of records in a database, in accordance with an embodiment of the present invention;

FIG. 11 is a system in accordance with a preferred embodiment of the present invention;

FIG. 12 shows a searching process in accordance with an embodiment of the present invention;

FIG. 13 is a screen shot of a categorizer in accordance with an embodiment of the present invention;

FIG. 14 is a representation of categories and reads in accordance with an embodiment of the present invention;

FIG. 15 illustrates a method of distributing, indexing and retrieving data in a distributed data retrieval system, according to an embodiment of the present invention;

FIG. 16 illustrates the distribution of data information and the formation of sub-collections in a distributed data retrieval system, according to an embodiment of the present invention;

FIG. 17 illustrates an inverted index from which a sub-collection view can be generated in a distributed data retrieval system, according to an embodiment of the present invention;

FIG. 18 illustrates a sub-collection view, according to an embodiment of the present invention;

FIG. 19 illustrates the paths of communication forming a network between a central computer and a series of local computers in a distributed data retrieval system, according to an embodiment of the present invention; and

FIG. 20 illustrates a global view, according to an embodiment of the present invention.

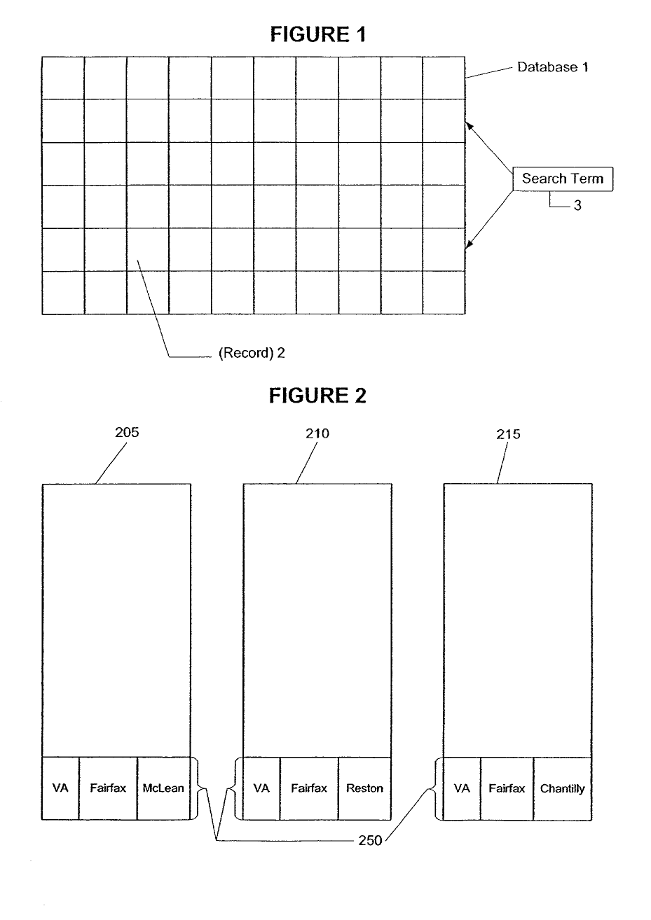

### DETAILED DESCRIPTION OF THE INVENTION

On-line computer services, such as the Internet, have grown immensely in popularity over the last decade. Typically, such an on-line computer service provides access to a hierarchically structured database where information within the database is accessible at a plurality of computer servers which are in communication via conventional telephone lines or T1 links, and a network backbone. For example, the Internet is a giant internetwork created originally by linking various research and defense networks (such as NSFnet, MILnet, and CREN). Since the origin of the Internet, various other private and public networks have become attached to the Internet.

The structure of the Internet is a network backbone with networks branching off of the backbone. These branches, in turn, have networks branching off of them, and so on. Routers move information packets between network levels, and then from network to network, until the packet reaches the neighborhood of its destination. From the destination, the destination network's host directs the information packet to the appropriate terminal, or node. For a more detailed description of the structure and operation of the Internet, please refer to “The Internet Complete Reference,” by Harley Hahn and Rick Stout, published by McGraw-Hill, 1994.

A user may access the Internet, for example, using a home personal computer (PC) equipped with a conventional modem. Special interface software is installed within the PC so that when the user wishes to access the Internet, a modem within the user's PC is automatically instructed to dial the telephone number associated with the local Internet host server. The user can then access information at any address accessible over the Internet. One well-known software interface, for example, is the Microsoft Internet Explorer (a species of HTTP Browser), developed by Microsoft.

Information exchanged over the Internet is often encoded in HyperText Mark-up Language (HTML) format. HTML encoding is a kind of markup language which is used to define document content information and other sites on the Internet. As is well known in the art, HTML is a set of conventions for marking portions of a document so that, when accessed by a parser, each portion appears with a distinctive format. The HTML indicates, or “tags,” what portion of the document the text corresponds to (e.g., the title, header, body text, etc.), and the parser actually formats the document in the specified manner. An HTML document sometimes includes hyper-links which allow a user to move from document to document on the Internet. A hyper-link is an underlined or otherwise emphasized portion of text or graphical image which, when clicked using a mouse, activates a software connection module which allows the users to jump between documents (i.e., within the same Internet site (address) or at other Internet sites). Hyper-links are well known in the art.

One popular computer on-line service is the Web which constitutes a subnetwork of on-line documents within the Internet. The Web includes graphics files in addition to text files and other information which can be accessed using a network browser which serves as a graphical interface between the on-line Web documents and the user. One such popular browser is the MOSAIC web browser (developed by the National Super Computer Agency (NSCA)). A web browser is a software interface which serves as a text and/or graphics link between the user's terminal and the Internet networked documents. Thus, a web browser allows the user to “visit” multiple web sites on the Internet.

Typically, a web site is defined by an Internet address which has an associated home page. Generally, multiple subdirectories can be accessed from a home page. While in a given home page, a user is typically given access only to subdirectories within the home page site; however, hyper-links allow a user to access other home pages, or subdirectories of other home pages, while remaining linked to the current home page in which the user is browsing.

Although the Internet, together with other on-line computer services, has been used widely as a means of sharing information amongst a plurality of users, current Internet browsers and other interfaces have suffered from a number of shortcomings. For example, the organization of information accessible through current Internet browsers and organizers such as Microsoft Internet Explorer or MOSAIC, may not be suitable for a number of desirable applications. In certain instances, a user may desire to access information predicated upon geographic areas as opposed to by subject matter or keyword searches. In addition, present Internet organizers do not effectively integrate the topical and geographically based information in a consistent manner.

In addition, given the large volume of information available over the Internet, current systems may not be flexible enough to provide for organization and display of each of the kinds of information available over the Internet in a manner which is appropriate for the amount and kind of data to be displayed.

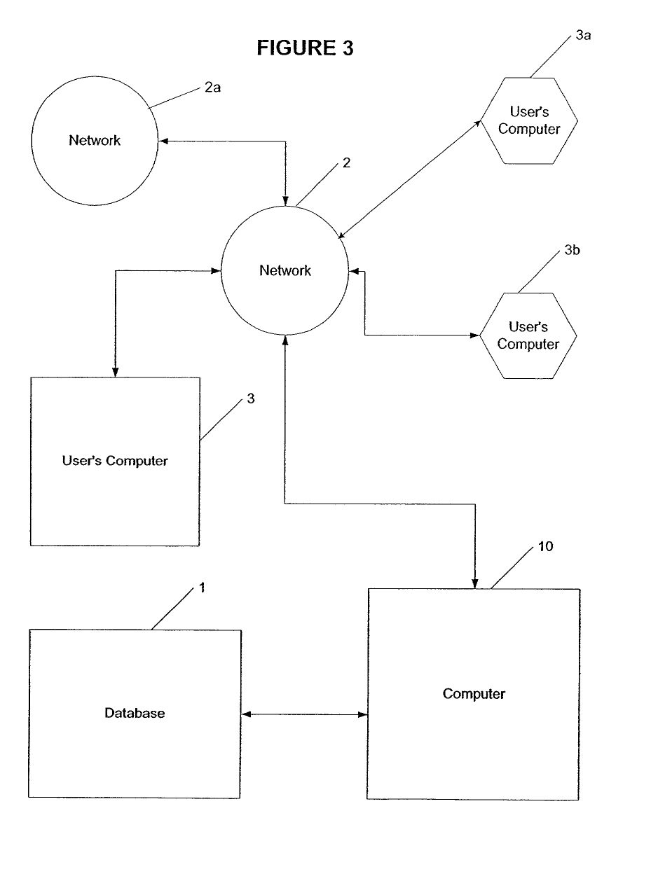

FIG. 3 is a system overview in accordance with a preferred embodiment of the present invention. A plurality of user computers 3, 3a and 3b are coupled to a network 2. Network 2 is also coupled to another network 2a which itself is coupled to other computers (not shown). Computer 10 is also coupled to network 2. Coupled to computer 10 is database 1. Database 1 contains a plurality of records (not shown).

The network 2 may be a private or public network, an intranet or Internet, or a wide or local area network which not only connects the user 3 but other users 3a, 3b and other networks 2a to computer 10.

For ease of understanding, in the discussion which follows, the network 2 will comprise the Internet, though this need not be the case.

It should be understood that database 1 comprises a multiple-taxonomy, categorized database. In such a database the records have been tagged or otherwise categorized by more than one taxonomy. For example, the records in database 1 have been categorized by the taxonomies “Location” and “Industry.” Each taxonomy, in turn, comprises a number of categories. To distinguish the categories and taxonomies used to tag records within database 1 from those selected by the user, the categories and taxonomies used to tag the records will be referred to as “database categories” and “database taxonomies.”

In one embodiment of the invention, computer 10 receives search requests in the form of data (hereafter referred to as “search-related data”) via network 2 from user computer 3. Search-related data comprise a search term entered by a user to initiate a keyword search, or a taxonomy or category selected by the user by “clicking on” a portion of a screen.

The category and/or taxonomy selected by the user and sent to computer 10 is a way for the user to navigate a Web site. As such, the category will be referred to as a “navigational category” and the taxonomy will be referred to as a “navigational taxonomy.”

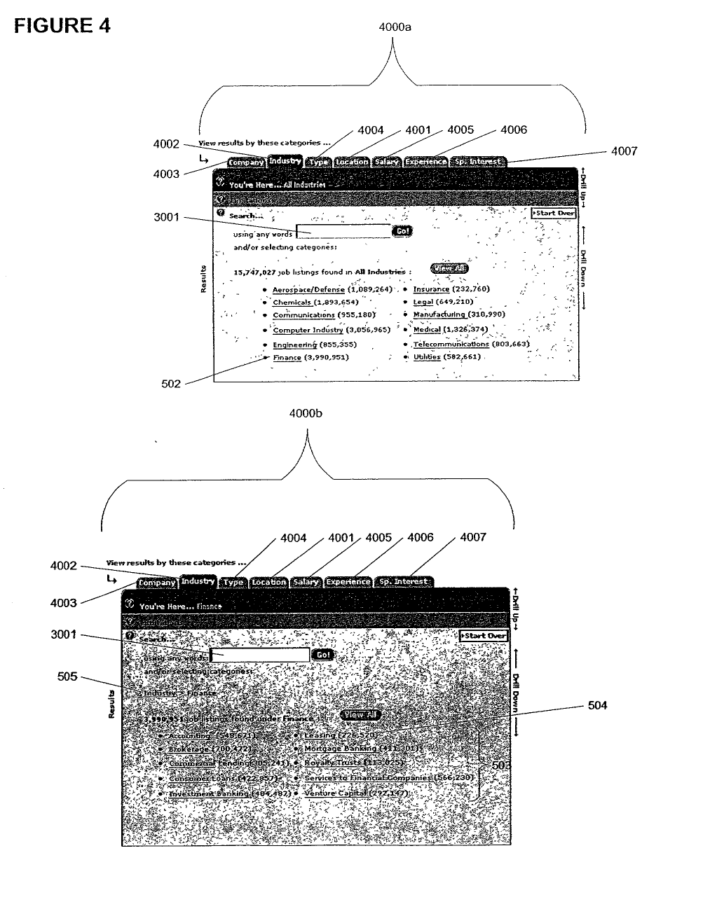

For example, when the user accesses a web site, like web site 4000a and 4000b in FIG. 4, he/she is presented with an initial screen which displays taxonomies 4001 and 4002, namely “Location” 4001, “Industry” 4002, “Company” 4003, “Type” 4004, “Salary” 4005, “Experience” 4006 and “Special Interest” 4007. The user may then insert a search term 3001 and select a taxonomy 4002. After selecting a taxonomy, the user then selects a category 502.

Once computer 10 receives the search-related data, the present invention utilizes the navigational taxonomy 4002 and category 502 in the user's search request to determine sub-categories from the hierarchy associated with the navigational taxonomy and category.

For instance, if the category 502 comprises “Finance,” then the process might yield sub-categories 503 shown in FIG. 4000b. One such sub-category 503 is “Leasing” 504. Sub-categories 503 will be referred to as “navigational sub-categories.”

Once computer 10 has determined the sub-categories 503, it then can launch a search directed to database 1.

It will be appreciated that the present invention envisions computer 10 launching search queries aimed at database 1 using sub-categories 503 which are not selected by the user. Rather, these sub-categories are dynamically selected by computer 10 based on the taxonomies and/or categories input by the user.

According to one embodiment of the present invention, a search query may be carried out in a number of ways.

For example, in one illustrative embodiment of the present invention computer 10 launches a search query comprising a search term 3001, a taxonomy 4002 and sub-categories 503 directed to database 1. Computer 10 compares the navigational taxonomy and sub-categories 503 to the database taxonomies and sub-categories making up database 1. If a record is tagged with a database taxonomy and a sub-category which matches a navigational taxonomy and sub-category, then that record must contain characters which are responsive to the user's search. After a match is detected, computer 10 compares the search term 3001 against only those records having matching taxonomies/categories.

Once the matching records have been identified, computer 10 generates a numerical count of all of the records within database 1 which have a character-string that matches the search term. This numerical count is further broken down by sub-category. For example, FIG. 4 shows “3,990,951” unique job listings for the category “Finance” 502. Within this, “226,500” relate to sub-category “Leasing” 504.

In another embodiment of the invention, computer 10 launches a search query comprising only a category or sub-category without a search term. This enables a user to “drill-down” through database 1 merely by selecting a narrower and narrower sub-category. In yet another embodiment of the invention, computer 10 is adapted to launch search queries comprising only a search term or terms. It should be noted that computer 10 initiates any one of these types of search queries at any level of drill-down.

In an illustrative embodiment of the present invention, a user may also drill-up through a hierarchy of categories/sub-categories. For example, once a user has drilled down and reached the level represented by screen 4000b in FIG. 4, he/she may click on the category “Industry” 505, and upon receiving this category as search-related data, computer 10 returns to screen 4000a in FIG. 4. In addition to drilling-up, the user 3 may switch taxonomies at any point in a drilldown or up. For example, the user can click on the “Location” taxonomy 4001 in FIG. 4 and be presented with categories corresponding to this taxonomy. In all cases, when the user clicks on or otherwise selects a taxonomy, category or sub-category, computer 10 compares the search-related data to a hierarchy as previously explained. A search is then launched by computer 10 using navigational sub-categories which result from this comparison.

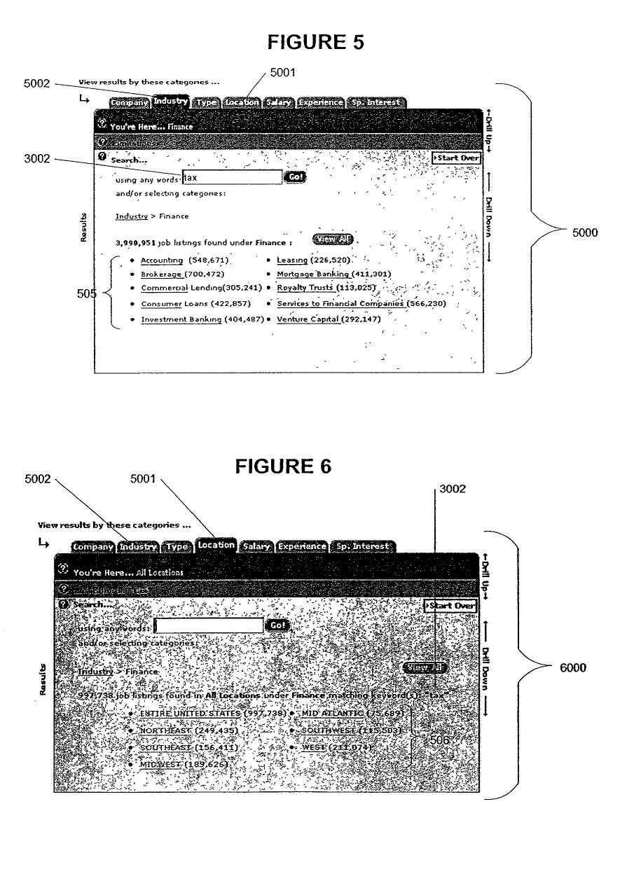

FIGS. 5 and 6 provide display screens 5000 and 6000 depicting other examples of how results from a search using two or more taxonomies 5001, 5002 can be displayed. Beginning with FIG. 5, there is shown an example of an initial screen 5000 which displays sub-categories 505 which make up a “Industry” taxonomy 5002. Though only a few categories are shown, it should be understood that categories 505 may comprise any type of industry, or some subset. In the example shown in FIG. 5, the user types in a search term “tax” 3002 and then clicks on the second “Location” taxonomy 5001. The present invention, however, is not limited to displaying the results of a search against only one taxonomy on one screen at the same time. Rather, the present invention can display the results of searches against multiple taxonomies on one screen at the same time.

Computer 10 then selects navigational sub-categories 506 which correspond to the “Location” taxonomy and subsequently launches a search query against database 1 using search term 3002, taxonomy 5001 and sub-categories 506. It should be noted that both taxonomies 5001, 5002 are provided to enable a user to initiate a search using either taxonomy.

Continuing, FIG. 6 depicts an example of a screen 6000 generated from the results of initiating the just described search query. As shown, the screen 6000 displays categories 506 which are navigational sub-categories related to the “Location” taxonomy 5001. In addition, the number of records containing characters matching the search term “tax” 3002 is also displayed. As before, this number is displayed as a total and is also broken down for each sub-category. For example, next to the category “Mid Atlantic” is the number “322,400” which indicates the number of records within database 1 that contain data or characters relating to job listings in the Mid Atlantic region.

It should be understood that the user need not input an additional keyword to further narrow his/her search. Instead, computer 10 generates intuitive sub-categories 506 which are presented to the user for the very purpose of narrowing his/her search. In addition, the number of matching records for each sub-category is displayed without the need for the user to individually launch separate searches aimed at each sub-category.

It should be understood that the terms “category” and “sub-category” are relative terms and in some instances may be used interchangeably.

The ability to switch among taxonomies, to drill-down or up, or to switch among taxonomies while drilling down or up enables the user to navigate a Web site and corresponding database 1 with great ease. This ease-of-navigation can be used to enable new revenue models. In one embodiment of the invention, new revenue models, such as advertising models, are enabled from such easy-to-navigate Web sites.

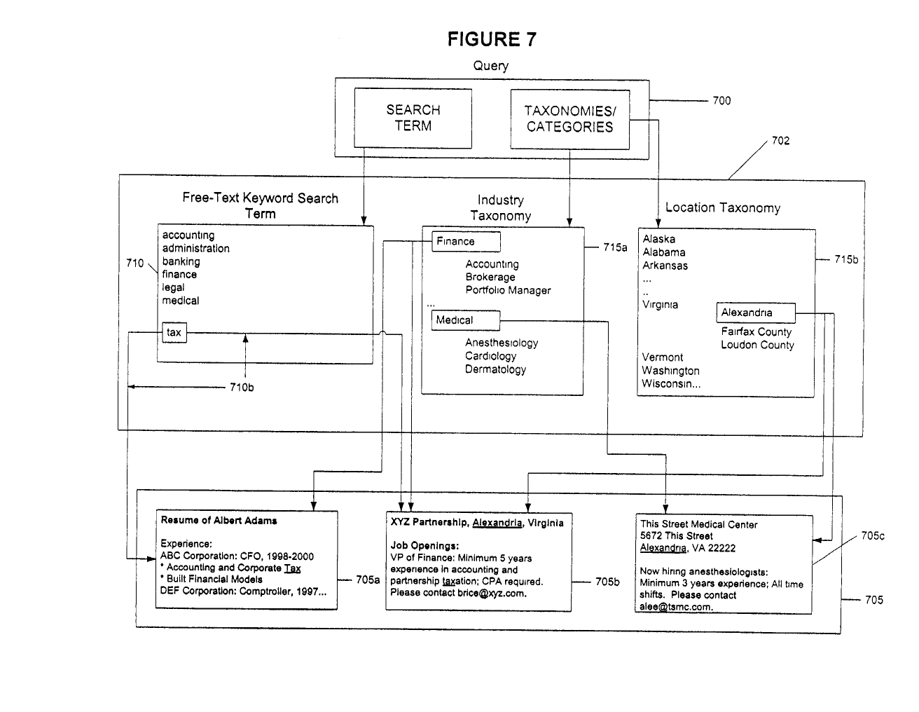

FIG. 7 provides a schematic of the data as it is stored and organized in a database in accordance with a preferred embodiment of the present invention. The database 705 contains many records, 705a, 705b, and 705c. In this example, a record is a single unit of identifiable data. Examples of records include individual Web pages, text documents, collections of video, still image, audio data, or any combination of these. It should be noted that there are other types of data that may be grouped together to form a record.

Three exemplary records are shown in FIG. 7. Record 705a is an individual's resume. Contained within this record is a word such as “tax.” A record such as this could be an HTML page (or XML document or database record) attached to a job applicant's home page. Once a user has accessed the home page, he/she would click on a link to access this text document to learn more about the job applicant's credentials. Records 705b and 705c are descriptions of job openings.

Indices/databases 710, 715a and 715b are used to access records in database 705. Inverted index 702 contains a listing of all the key words and phrases 710 in all of the records in database 705, and other indices 715a and 715b. Examples of such key words and phrases include “accounting,” “administration,” “banking,” “finance,” “legal,” “medical”and “tax.” Attached to each of these key words and phrases are links 710b. These links reference each record in index/database 705 that contains these words and phrases.

Indices/databases 715a and 715b represent different taxonomies of database 705. As shown by the headings, index/database 715a is a “Industry” taxonomy of database 705 and index/database 715b is a “Location” taxonomy of database 705.

These three indices/databases 710, 715a and 715b are used to access the records in database 705 in three different ways. Index/database 710 receives search terms or phrases and is scanned to locate those key word or phrases. When a hit is discovered, the number of links 710b that reference into database 705 is then determined.

Indices/databases 715a and 715b provide data collection lists of their respective contents in response to user input. As an example, if the user clicks on the “Industry” taxonomy, all of the categories within that taxonomy are displayed. Two of those categories include “Finance” and “Medical.” As shown in FIG. 7, each of these categories is divided into sub-categories like “Accounting,” “Brokerage,” “Portfolio Management,” “Anesthesiology,” “Cardiology” and “Dermatology.”

Index/database 715b is a taxonomy of database 705 based on “Location.” Within taxonomy 715b are categories. An easy example is a listing of states or counties. Each state is sub-categorized by county.

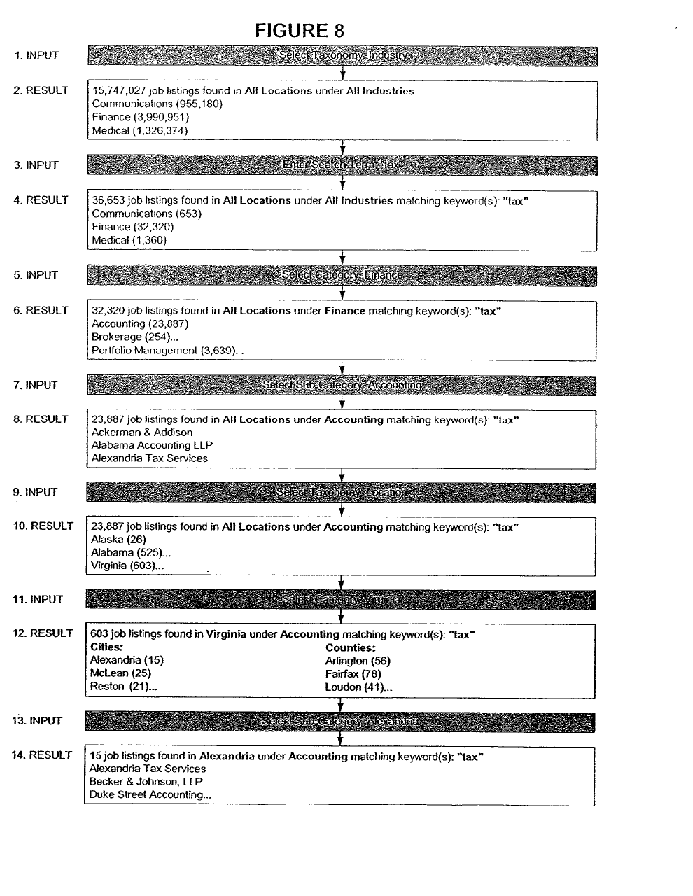

By having multiple taxonomies of the single database, multiple paths are possible to reach the same records. FIG. 8 shows one set of queries from a user and the system responses that represent a path a user may take to reach the records he/she desires. The user begins by typing in a search term against the “Industry” taxonomy, however in an alternative embodiment of the present invention, the user could begin a search against multiple taxonomies. In the example given the search term is “tax.” The present invention queries term index 710 and determines that 36,653 records in the database have the word “tax” within them.

The present invention then determines the categories that are associated with the search term “tax.” For example, almost all of the records that have the search term “tax” in them are categorized into the group of “Finance.” The user selects the “Finance” category and the present invention then searches through index 715a to determine how many records within each of the sub-categories also are associated with the search term “tax.” As shown in FIG. 8, only 254 records organized into the “New Car Sales” category contain the keyword “tax” while 23,887 records organized into the “Accounting” category contain the keyword “tax.” Thus the present invention compounds all of this data and provides it to the user. It should be noted that by pushing data back to the user, in this case a glimpse of the organization of the categories, the user can learn how best to proceed with drilling down into the data.

The user responds to the list of sub-categories provided by the present invention by selecting one. In this example, the user selects the “Accounting” sub-category.

The system responds by providing a list of all 23,887 job listings that are associated with the search term “tax.” This list is unruly for a human being to wade through so the user clicks on the “Location” taxonomy in response.

The system responds by cross-matching the 23,887 records against the categories within the “Location” taxonomy. Thus, the system generates a data collection of these 23,887 records as organized by state (i.e., Virginia has 603, etc.).

The user responds to these sub-categories by selecting a particular state, say Virginia. The system responds by cross-matching the sub-categories within Virginia. In this example, the sub-categories are the various counties and city municipalities within Virginia. Once the cross-matching is completed, the system provides the user with a list of appropriate sub-categories with how many records match the search so far.

The user responds by selecting a particular county or municipality, say Alexandria. The system responds by providing a list of all 15 records that match the search. Thus, the listed records are a match of the search term “tax;” the taxonomy “Industry;” the category “Finance;” the sub-category “Accounting;” the taxonomy “Location;” the category “Virginia;” and the subcategory “Alexandria.”

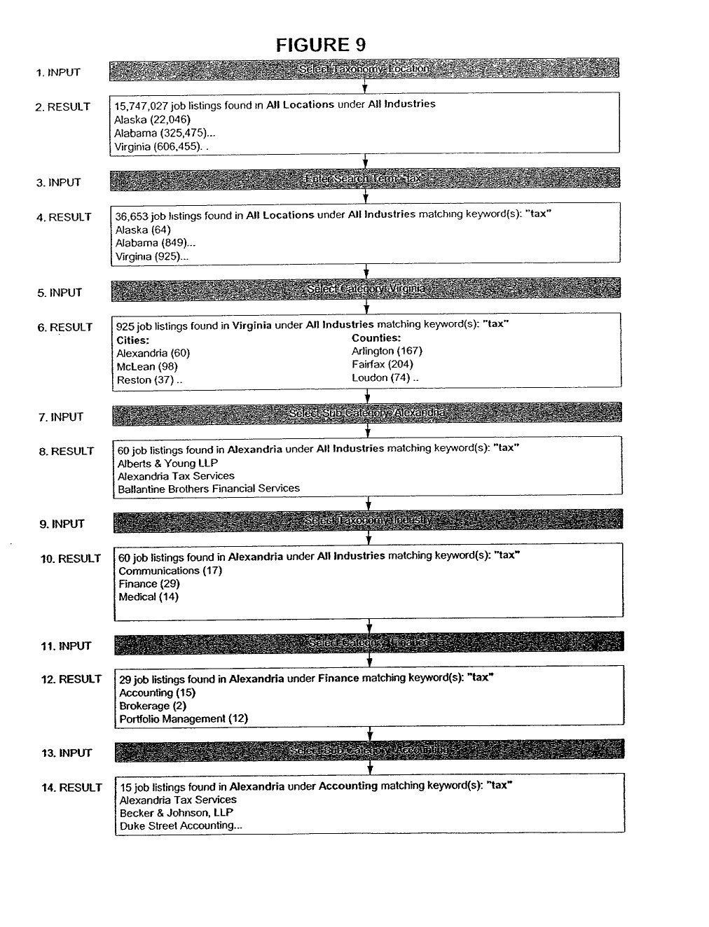

FIG. 9 shows another set of user queries and system responses that represent another path the user may use to get to the same set of records. The user begins this search by requesting details about the “Location” taxonomy. The system responds by returning the list of states with a count of how many records are associated with each state.

The user responds by entering the search term “tax.” The system cross-matches the search term “tax” in free-text term index 910 with each state. This produces a category list of states with the number of records associated with the search term “tax” in parentheses.

The user responds by selecting one of the listed categories. Following with the example given in conjunction with FIG. 8, the user selects “Virginia.”

The system responds by providing a list of sub-categories under the category “Virginia.” In this example, the system responds by providing the list of municipalities and counties such as “Alexandria” and “Fairfax” County. The user responds by selecting a sub-category, such as “Alexandria.”

The system responds by providing a list of all 60 job listings in Alexandria that are associated with the search term “tax.” The user responds by selecting the “Industry” taxonomy. The system responds by cross-matching all of the categories in the “Industry” taxonomy with the selected category “Alexandria.” Thus, the system generates a data collection of these 60 records as organized by Industry (i.e., Finance has 29, etc.).

The user responds to these sub-categories by selecting “Finance.” The system responds by cross-matching the sub-categories within “Finance.” In this example, the sub-categories are the various financial services, such as “Accounting” and “Portfolio Management.” Once the cross-matching is completed, the system provides the user with a list of appropriate sub-categories with how many records match the search so far.

The user responds by selecting “Accounting.” The system responds by listing the 15 records that match that search. In this example, the records match the taxonomy “Location;” the search term “tax;” the category “Virginia;” the sub-category “Alexandria;” the taxonomy “Industry;” the category “Finance;” and the sub-category “Accounting.” This is a different search path to the one described in FIG. 8, yet it yields the same results.

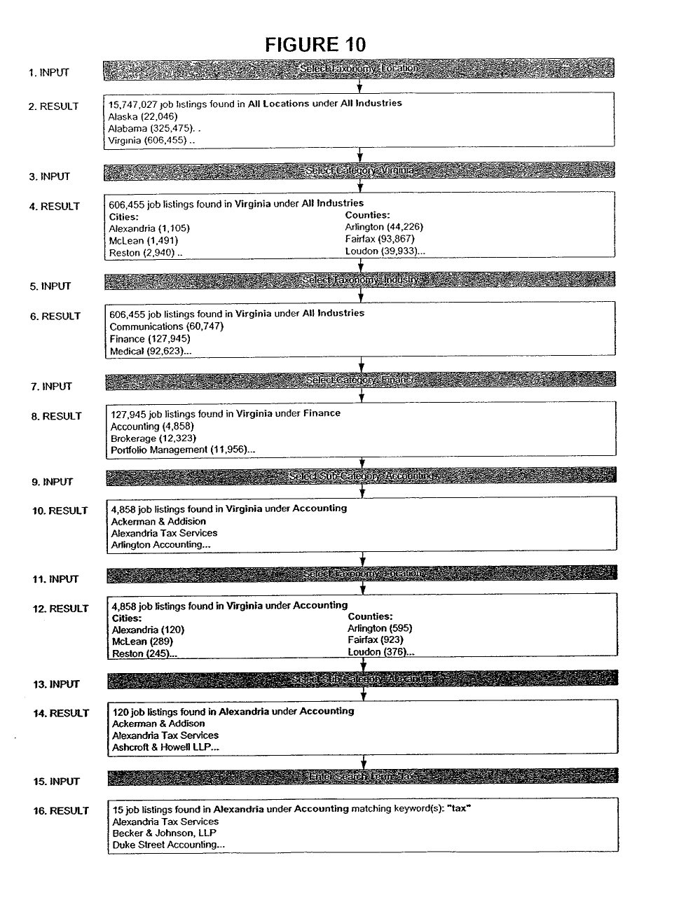

FIG. 10 shows yet another set of user queries and system responses that represent yet another path the user may travel in order to obtain the desired records. The user begins by selecting the “Location” taxonomy. The system responds by listing all of the categories with all the records associated with each category in parentheses. In this example, each state category is listed along with its number of associated records.

The user responds by selecting one of the listed categories. Again, the user selects “Virginia.” The system responds by listing the sub-categories under the selected category along with the number of associated records in parentheses.

The user responds by selecting the “Industry” taxonomy. The system responds by crossmatching all of the categories in the “Industry” taxonomy with the selected category “Virginia.” The system then provides the user with a list of categories in the “Industry” taxonomy. Examples of categories in this taxonomy are “Communications,” “Finance” and “Medical.”

The user responds by selecting a particular category. Following with the above examples, the user selects the category “Finance.” The system responds by providing the sub-categories within the category “Finance.” The number in the parentheses corresponds to the number of records that are associated with the category “Virginia” and each of the listed sub-categories within this category of “Finance” (i.e., “Accounting,” “Brokerage,” “Portfolio Management,” etc.).

The user responds by selecting the sub-category “Accounting.” The system responds by providing a list of all of the records that match the search. The user refines the search via the “Location” taxonomy. Thus, the user selects the “Location” taxonomy and the system responds by cross-matching the records associated with the sub-category “Accounting” with the categories of the “Location” taxonomy (i.e., cities or counties in Virginia). The system then displays the listing of categories with the number of records associated with the sub-category “Accounting” and each city or county in Virginia.

Thus, the system responds by listing the sub-categories under the category “Virginia” (i.e., “Alexandria,” “Fairfax County,” “Arlington County, ” etc.) with the number of records associated with “Accounting” in parentheses.

The user selects a listed sub-category. Following the above example, the user selects “Alexandria.” The system responds by listing all of the “Accounting” associated records that are also associated with “Alexandria” in “Virginia.”

The user responds by entering the search term “tax.” The system receives this query, matches records associated with the search term “tax” from free-text term index against the terms stored therein and cross-matches those records associated with the search term “tax” with the listed records. This produces a list of 15 records that match the search. In this example, the listed records match the taxonomy “Location;” the category “Virginia;” the taxonomy “Industry;” the category “Finance;” the sub-category “Accounting;” the taxonomy “Location;” the category “Virginia;” the sub-category “Alexandria” and the search term “tax.”

These three examples demonstrate the versatility of the present invention. First, the user is not required to go through a specific path to reach the desired number of records. While the above examples show only three paths to reach the desired set of records, it can be appreciated that there are multiple paths to reaching the same set of records.

This plurality of paths is achieved by the independence of the two taxonomies shown in FIG. 7. By keeping these taxonomies independent, the user may switch between which taxonomy he/she wishes to use to consider the data and make queries into database 705. The level of the search that the user uses to make a decision to switch among taxonomies is also arbitrary and up to the user. This allows users who are more proficient in developing location-based searches to use their proficiency in that index to whittle the number of records down before going into the “Industry” index to finish the search where the user is less proficient, and vice versa.

Another feature of the present invention is the pushing of data to the user. As noted above, the user receives category and sub-category information when a query via a search term is used earlier in the process. As noted above, suppose the user is looking for job listings in the trusts and estates area, instead of tax. By typing the search term “estates,” the system will provide the category list to the user so that he/she can drill down into the data. Thus, if there were a sub-sub-category of “tax” the user would eventually see that sub-sub-category and make the association between “tax” and “estates.” Thus the user comes in contact with a useful category or sub-category that he/she can use to search for desired information.

Another advantage of the present invention is the way results are provided to the user. As noted in the many examples above, much of the sifting through the database is done via the categories and sub-categories. In a preferred embodiment, there are many more records in the database than there are categories. As an example, a search term may be associated with thousands of records, but only one category. Providing a list of thousands of records requires a lot of data handling in both the transmission of the data to the user, as well as the displaying of the data to the user. Providing a list of only one category is much less data to transmit and display. This makes the invention ideal for use with devices with small screens, such as cell phones, pagers, and personal digital assistants (PDAs) and palm-held devices.

FIG. 14 is a representation of a portion of the data stored in structure 702 and how that data is organized in accordance with a preferred embodiment of the present invention. Node 1405 represents the category “Virginia” from the “Location” taxonomy. Node 14 10 represents the sub-category “Arlington.” Node 1415 represents the sub-category “Fairfax.” Node 1420 represents the sub-category “Service” from the “Products and Services” taxonomy. Record 1425 represents a single record.

Linking the nodes and records are category code words. Category information is stored in the inverted index as an encoded category codeword. Leading into node 1405 is a category code word called “VA.” Leading into node 1410 is a category code word called “AR.” Leading into node 1415 is category code word “FX.” Leading into Record 1425 are links R1 and R2. This representation shows how the various categories relate to each other and the records.

In one embodiment of the present invention, these category code words are stored in inverted index 702 and used to retrieve records. This structure provides several advantages. First, the amount of data searched in the inverted index is reduced. Instead of searching for a string of 8 characters (i.e., “Virginia”), the string searches are reduced to only 2 characters (i.e., “VA”). In addition, the amount of data stored in the cache, as is described below, is also reduced from, in this example, 8 characters to 2 characters. This reduces the time that is required to determine if there is a cache hit.

It will be appreciated that large global collections of data can be broken down into smaller sub-collections. The sub-collections can be stored independently one from the other, as in separate physical locations or simply in separate data tables within the same physical location, and can be connected one to the other through a network or stored locally. As data are added to the large global collection overall, it can be sent and added to individual sub-collections and/or can be formed into a further sub-collection. For instance, data entered by educational institutions and scientific research facilities can be stored independently in their own data storage facilities and connected to one another via a network, such as the Internet. Thus, as can be seen, the present invention can be implemented with very little or no change in the present protocol for data collection and storage.

It will be appreciated that the present invention provides a search interface that can aggregate disparate databases and make the disparate databases searchable through one interface.

Once the individual sub-collections have been identified, each performs its own indexing function. In carrying out the indexing function, each sub-collection creates its own sub-collection view consisting of statistical information generated from what is commonly referred to as an inverted index. An inverted index is an index by individual words listing documents which contain each individual word. The indexing function itself can be carried out in any method. For example, indexing can be performed by assigning a weight to each word contained in a document. From the weights assigned to the words in each document, a sub-collection view (i.e., the statistical information derived from the inverted index) is created upon completion of the indexing function. Regardless of how the sub-collection indexing is carried out, each sub-collection will have its own independent sub-collection view based upon that sub-collection's inverted index. When data information is added to the sub-collection, the indexing function is carried out again and the sub-collection's view can be re-compiled from a new inverted index.

Upon completion of each sub-collection view, certain statistical information about the sub-collection view is gathered by a global collection manager to form a global collection of parameters, statistics, or information. The global collection manager may either request from each sub-collection that it send its sub-collection view, and/or each of the sub-collections may spontaneously send the sub-collection view to the global collection manager upon completion. Regardless of whether the taxonomies are requested or spontaneously sent, upon collection at the global collection manager of all of the sub-collection's views, the global collection manager builds a “global view” on the basis of the sub-collection views. Necessarily, the global view is likely to be different from each of the individual sub-collection views. Once the global view has been compiled, it is sent back to each of the sub-collections.

In this manner then, a distributed data retrieval system is built and is ready for search and retrieval operations. To search for a particular piece of data information, a system user simply enters a search query. The search query is passed to each individual sub-collection and used by each individual sub-collection to perform a search function. In performing the search function, each sub-collection uses the global view to determine search results. In this manner then, search results across each of the sub-collections will be based upon the same search criteria (i.e., the global view).

The results of the search function are passed by each individual sub-collection to the global collection manager, or the computer which initiated the search, and merged into a final global search result. The final global search result can then be presented to the system user as a complete search of all data information references.

These time savings are increased as the length of the path is increased. If the entire path length from base node to record node includes fifty of these node-to-node or node-to-record links, the search is reduced from 400 characters to 100.

The labeling of these paths also reduces computation time for other searches. For example, if the search is a proximity search (i.e., Is store X within 5 miles of apartment Y?), the present invention can be used to make this determination. For example, if in one path to the record associated with store X is the path name “SC” for South Carolina and in the corresponding path to the record apartment Y is the path name “MD” for Maryland, the system can immediately determine that the answer to this query is No by merely referring to the path names.

It should be noted that other variations are possible with this embodiment of the invention without departing from the scope of the invention. For example, the number of characters used to describe a category is not limited to two and may in fact be any number of characters. Additionally, the category code words need not be limited to letters but may encompass numbers, symbols or a combination of letters, numbers and symbols. In addition, once the category code words between the base node and each record are determined, they may be stored within the records as tags in a preferred embodiment of the present invention.

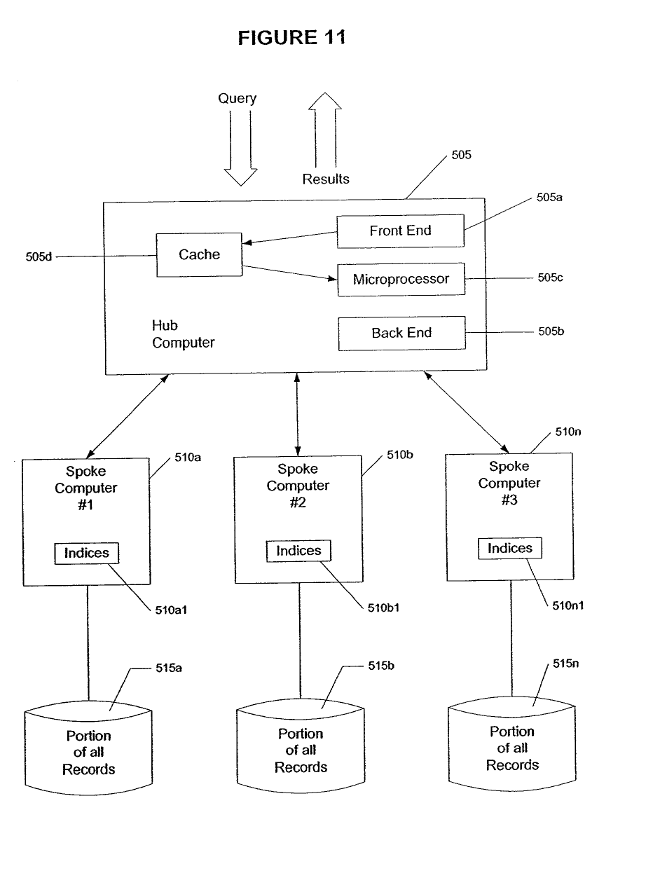

FIG. 11 shows a system overview in accordance with an embodiment of the present invention. Hub computer 505 is the central point. It receives queries from and provides compiled results to users. Hub computer 505 is comprised of front end 505a, back end 505b, microprocessor 505c and cache memory 505d. Front end 505a is used to receive queries from users and format the results so that they are in a compatible format for the user to understand. Back end 505b uses the appropriate protocols to issue broadcast messages and receive messages. Coupled to hub computer 505 are spoke computers 510a, 510b through 501n. Spoke computers 510a-510n have local memories 510a1-510n1 that are used to store indices. Coupled to each spoke computer 510a-510n is large memory storage 515a-515n used to store the records in database 705.

In a preferred embodiment of the present invention, hub computer 505 and spoke computers 510a-510n are Intel-based machines. The communications between the hub computer 505 and spoke computers 510a-510n are based on the TCP/IP format. Spoke computers 510a-510n operate using a standard database language, such as SQL. Hub computer 505 uses Visual Basic and C++ to process data.

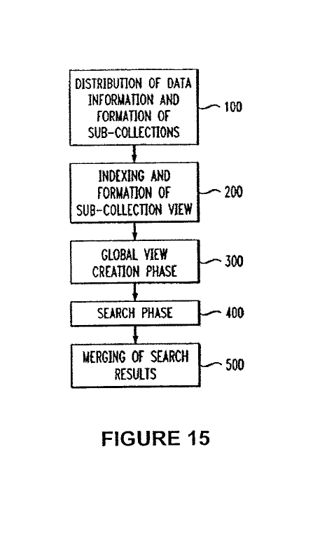

FIGS. 15 through 20 show a method and an apparatus for the efficient and effective distribution, storage, indexing and retrieval of data information in a distributed data retrieval system which is fault tolerant. Large amounts of data may be searched and retrieved faster by distribution of the data, separate indexing of that distributed data, and creation of a global index on the basis of the separate indexes. A method and apparatus for accomplishing efficient and effective distributed information management will thus be shown below.

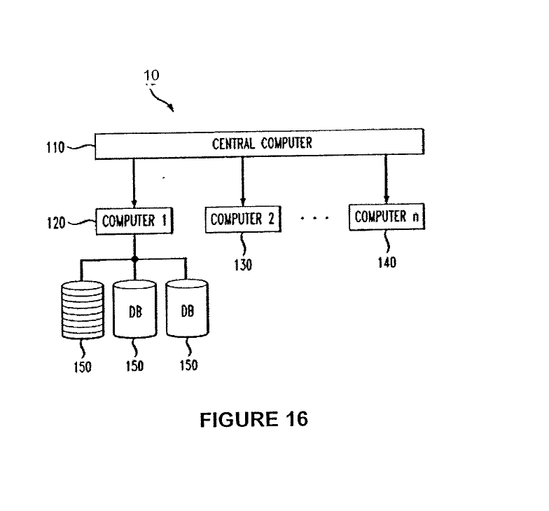

Referring to FIGS. 15 and 16, in step 100 of FIG. 15 data information is distributed and formulated into sub-collections 150 of FIG. 16. The process of distributing the data may be accomplished by sending the data from a central computer terminus 110 to local nodes 120, 130 and 140 of a computer network 10, or by directly entering the data at the local nodes 120, 130 and 140. Further, the data may be divided such that the divided data is of equal or unequal sizes, and so that each division of the data has a relational basis within that division (i.e., each division having an informational subject relation all its own). Such allowances for data entry and distribution allow for little or no change to current data entry and distribution protocols. In the case of the Web, data entry can continue as it does now. Each entity (i.e., Universities, Medical Research Facilities, Government Agencies, etc.) can continue to enter data as it sees fit. Thus, the sub-collections 150 can be organized in any fashion and be of any size.

In step 200 of FIG. 15, the data information, which has been divided and stored into the sub-collections 150, is indexed and a “sub-collection view” is formed. Indexing of the subcollection 150, like the step of distributing the data, can follow current protocols and may be computer-assisted or manually accomplished. It is to be understood, of course, that the present invention is not to be limited to a particular indexing technique or type of technique. For instance, the data may be subjected to a process of “tokenization”. That is, documents containing the data are broken down into their constituent words. The resulting collection of words of each document is then subject to “stop-word removal”, the removal of all function words such as “the”, “of” and “an”, as they are deemed useless for document retrieval. The remaining words are then subject to the process of “stemming”. That is, various morphological forms of a word are condensed, or stemmed, to their root form (also called a “stem”). For example, all of the words “running”, “run”, “runner”, “runs”, . . , etc., are stemmed to their base form run. Once all of the words in the document have been stemmed, each word can be assigned a numeric importance, or “weight”. If a word occurs many times in the document, it is given a high importance. But if a document is long, all of its words get low importance. The culmination of the above steps of indexing convert a document into a list of weighted words or stems.

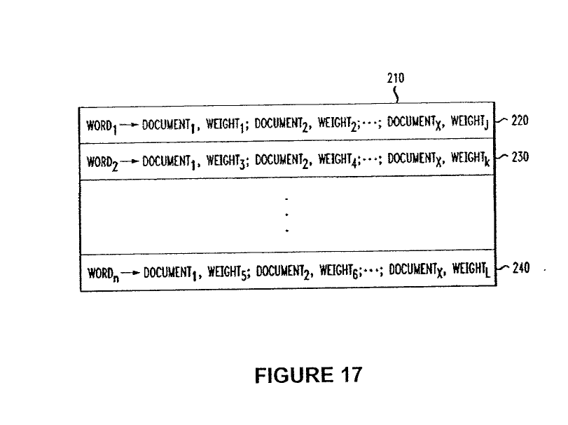

Regardless of the indexing technique used, the index thus far created is then inverted and stored as an “inverted index”, as shown in FIG. 17. Inversion of the index requires pulling each word or stem out of each of the documents of the index and creating an index based on the frequency of appearance of the words or stems in those documents. A weight is then assigned to each document on the basis of this frequency. Thus, the inverted index, has the form of:

word.sub.i .fwdarw.document.sub.a, weight.sub.a; document.sub.b, weight.sub.b; . . . ; document.sub.z, weight.sub.z.

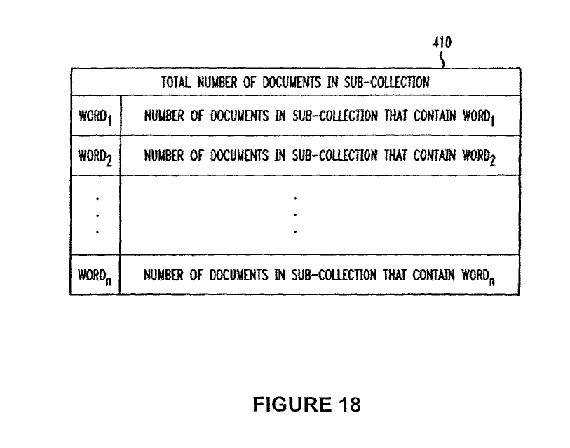

The inverted index 210 itself, as shown in FIG. 17, is composed of many inverted word indexes 220, 230 and 240, and can thus be created and organized. As shown, each inverted word index 220, 230 and 240 composes an index of a different word, taken from the documents of the initial index, such that each document is weighted in accordance with the frequency of appearance of the word in that document. Completion of the inverted index 210 allows the derivation of statistical information relating to each word and thus the creation of a sub-collection view 410, as shown in FIG. 18. The statistical information which makes up the sub-collection view 410 includes the total number of documents in the sub-collection 150 and, relating to each word, the number of documents in the sub-collection that contain that word. As each computer is indexing its sub-collection separately, the total indexing time for indexing the entire collection is greatly reduced as it is now shared across many computers. It is to be understood, of course, that any method of indexing may be used to form the sub-collection view 410 and that the above described method is but one of many for accomplishing that goal.

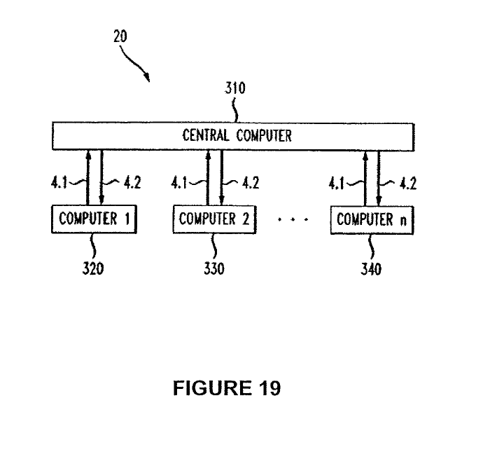

In step 300 in FIG. 15, once the sub-collection view 410 is created, a global view is created and distributed. For formation of the global view, each sub-collection view 410 which has been created is collected from the local nodes 120, 130 and 140 of the computer network 10 and sent to the central computer 110. Referring to FIG. 19, showing an embodiment of the paths of communication of a computer network 20, sub-collection views from computers 320, 330 and 340 are sent to central computer 310 along communication paths 4.1. Collection and sending of the sub-collection view can be initiated by either the central computer 310 or the local computers 320, 330 and 340. If collection of the sub-collection views 410 is initiated by the central computer 310, it may be initiated by individual commands sent to each computer in the network 20, or as a group command sent to all of the computers in the network 20. If the collection of the sub-collection views 410 is initiated by the local computer 320, 330 or 340, then the local computer may send the sub-collection view upon occurrence of completion of the sub-collection view, an update of the sub-collection view, or some other criteria, such as a specific time period having elapsed, etc. It is to be understood, of course, that any method by which the completed sub-collection views are sent to the central computer from the local computers is acceptable.

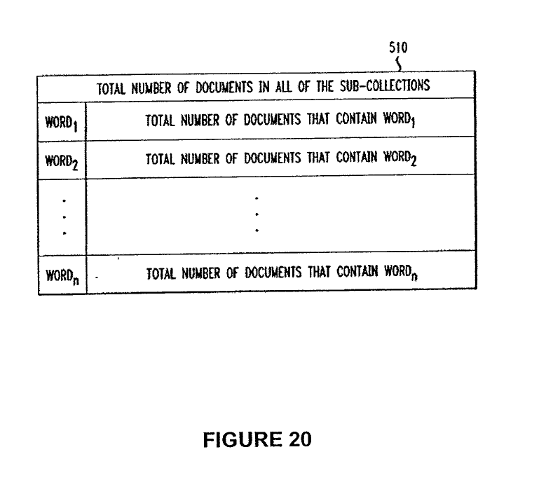

Upon collection of all of the sub-collection views 410, a global view 510 is created as shown in FIG. 20. In the formation of the global view 510, the central computer 310 uses the sub-collections 410 that have been sent from every local computer 320, 330 and 340 to determine how many documents are contained in the sub-collection residing at the particular local computer, and for every word, how many documents in the sub-collection contain the word in question. The global view 510 then comprises information pertaining to how many documents there are in all of the sub-collections (i.e., the total document sum) and for every word, how many documents in all of the sub-collections contain the word in question. The global view, then, provides all of the necessary information for use in weighting the words in a user query, as will be explained below. It is to be understood, of course, that any method which provides the central computer with the information necessary to form the global view may be used. For instance, the sub-collection views need not be sent in their entirety themselves, but instead the nodes could send only statistical information about their subcollection(s).

To complete step 300 of FIG. 15, the global view 510 is sent from the central computer 310 to each of the local computers 320, 330 and 340 by way of communication paths 4.2 (as shown in FIG. 19). Thus each local node in the network will now have the global view. It is to be understood, of course, that the description of the formation of the sub-collection views and subsequent formation of the global view can be conducted on any computer network, and thus computer networks 10 and 20 are to be considered interchangeable in this description.

In step 400 of FIG. 15, the search phase is conducted. The search phase refers to search and retrieval of data information stored in the large data text corpora. Thus, to begin with, in the search phase a search query is entered and uploaded by a system user into the computer network 10. It is to be understood, of course, that the system user may enter the search query at any computer location that is connected to the computer network 10. Upon entry of the search query, the search query is transmitted by the computer network 10 to all of the local computers 120, 130 and 140 in the computer network 10.

After receiving the search query, each local computer 120, 130 and 140 then indexes the search query using the same steps that are used to index the documents, namely, for instance, “tokenization”, “stop word removal” and “stemming” and “weighting”. The resulting words (actually stems) in the query are assigned importance weights using the global view 510 which each local computer 120, 130 and 140 received in step 300. If a query word is used in many documents, then it is presumed to be common and is assigned a low importance weight. However, if a handful of documents use a query word, it is considered uncommon and is assigned a high importance weight. The “total number of documents in the collection” and the “number of documents that use the given word” statistics are only available to local computers 120, 130 and 140 after the global view creation.

It is to be noted, of course, that other formulae might be used as desired. If so, the sub-collection view may be adjusted to account for the different formula. It should also be noted that having each local computer perform an indexing of the search query might be necessary if the entry point of the search query is at a point which does not have access to the global view and thus cannot perform the indexing function. However, if the entry point for the search query does have access to the global view, then the search query can be indexed at the entry point and distributed in an indexed format.

The indexing of the search query, as shown above, yields a weighted vector for the search query of the form:

query.fwdarw.word.sub.1, weight.sub.1; word.sub.2, weight.sub.2; . . . ; word.sub.n, weight.sub.n.

Having indexed the search query, a simple formula is used to assign a numeric score to every document retrieved in response to the search query. This simple formula can be referred to as a “vector inner-product similarity” formula specifying the weight of a word in the search query and the weight of a word in the document being scored. Each document is then sent to the central computer 310, via communication paths 4.1, from the local computer nodes 320, 330 and 340.

In step 500 of FIG. 15, once all search results have been returned to the central computer via communication paths 4. 1, the central computer 310 merges the variously retrieved documents into a list by comparing the numeric scores for each of the documents. The scores can simply be compared one against the other and merged into a single list of retrieved documents because each of the local computers 320, 330 and 340 used the same global view 510 for their search process. Upon completion of the merging of the documents, a complete list is presented to the system user. How many of the documents are returned to the user can, of course, be pre-set according to user or system criteria. In this manner then, only the documents most likely to be useful, determined as a result of the system user's search query entered, are presented to the system user.

It should be noted that the manner in which the global view 510 is created provides a fault tolerant method of distributing, indexing and retrieving of data information in the distributed data retrieval system. That is, in the case where one or more of the sub-collection views is unable to be collected by the central computer, for whatever reason, a search and retrieval operation can still be conducted by the user. Only a small portion of the entire collection is not searched and retrieved. This is because failure by one or more local computers results in only the loss of the sub-collections associated with those computers. The rest of the data text corpora collection is still searchable as it resides on different computers.

Further, to provide even more fault tolerance, data information may be duplicatively stored in more than one sub-collection. Duplicative storage of the data information will protect against not including that data information in a search and retrieval operation if one of the sub-collections in which the data information is stored is unable to participate in the search and retrieval.

Thus the foregoing embodiment of the method and apparatus show that efficient and effective management of distributed information can be accomplished. The current invention of the division of the large data text corpora into sub-collections which are then separately indexed, which indexes are then used to form a global view, is possible, as shown herein, without a loss and, in fact, an increase in the effectiveness and efficiency of a search and retrieve system. Further, the search and retrieval operations take less time than current systems which either search the entire large collection all at once or which search individual collections.

This system implements the search queries described above in the following manner. First, hub computer 505 receives a query from the user. This query can be in the form of a search term, a taxonomy selection, a category selection, a sub-category selection, etc. Upon reception of the query, microprocessor 505c compares the query with data stored in cache 505d. If the response to the query is already stored in cache 505d, the microprocessor 505c returns that response as a result to the user. Hub computer 505 then waits for another query from the user.

If the query is not in cache 505d, microprocessor generates a broadcast message to be sent to all spoke computers 510a-510n. This broadcast message includes the user's query.

Upon reception, each spoke computer 510a-510n performs a search of the appropriate index stored therein using the query from the user. In a preferred embodiment of the present invention, each spoke computer 510a-510n stores all three indices 710, 715a and 715b in local memory as described above. In addition to broadcasting a request across the network to different machines, multiple threads could be used and the message could be broadcast to multiple processors in a single machine (on a bus rather than a network). Alternatively, the search request could be conducted locally—a single process, single thread, single machine search.

Also in the preferred embodiment, data storage 515a-515n each stores only a portion of the records in database 705. Since each set of data is unique in data storage 515a-515n, it follows that the relationships between the indices stored in local memories 510a1-510n1 are also unique because they cannot all access the same records. In an alternate embodiment, spoke computers 515a-515n all share identical copies of database 705, but the indices/databases 710, 715a, and 715b are parsed among local memory 510a-510n. Upon reception, each spoke computer 510a-510n performs a search of the appropriate index stored therein using the query from the user. In a preferred embodiment of the present invention, each spoke computer 510a-510n stores all three indices 910, 915a and 915b in local memory as described above. In addition to broadcasting a request across the network to different machines, multiple threads could be used and the message could be broadcast to multiple processors in a single machine (on a bus rather than a network). Alternatively, the search request could be conducted locally—a single process, single thread, single machine search.

Each spoke computer 510a-510n returns the results, either a list or the counts for each category, determined by its respective indices to hub computer 505. Hub computer 505 compiles those results and provides them to the user. In an alternate embodiment, spoke computers 515a-515n are also provided with cache memories to reduce the number of queries made to memories 515a-515n.

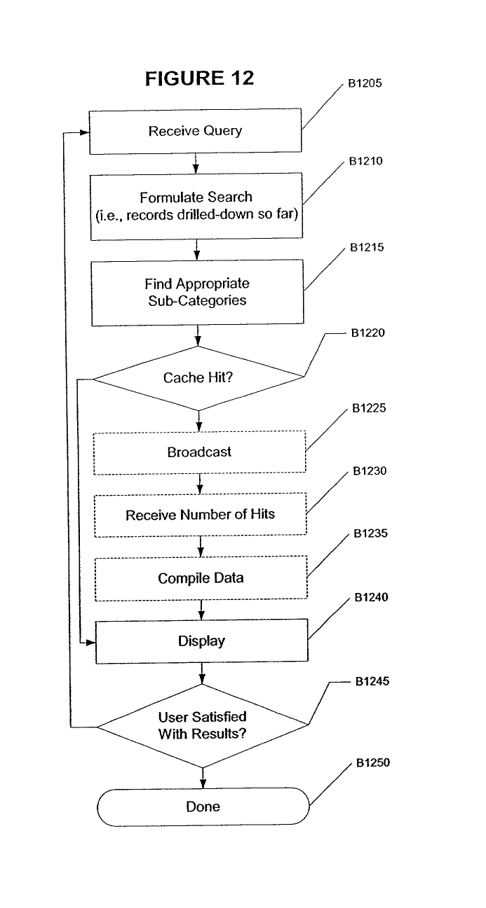

FIG. 12 is a system in accordance with the present invention. At block B1205, the system receives a query from the user. It should be noted that the query may be a term, a taxonomy, a category, a sub-category, a sub-sub-category, free text, a field, a numeric range, Boolean logic, combinations of elements, etc. At block B 1210, the query is formulated with respect to the current state of the present search. As an example, if the user enters the keyword “neurology,” the query is formulated such that the current taxonomy is taken into consideration (i.e., “Location”).

At block B1215, the system determines the appropriate categories or sub-categories to search through to locate records that match. As an example, one possible category is “Physicians.” From the determinations made in blocks B1210 and B1215, the system has narrowed the number of possible hits by discarding those records that do not conform to the selected category. It should be noted that, in a preferred embodiment, the categories or sub-categories are determined using an organized list such as a B-tree, another database or from the inverted index itself.

At block B 1220, the system checks its cache. The cache typically stores three types of data. The first type of data is a query result that was recently performed. Thus if user A issues a query for term X in category Y, and 1 minute later user B makes the identical query, the cache is used to provide the results, instead of determining the results anew. The second type of data stored in the cache is frequently requested queries. Suppose users are, in the aggregate, frequently requesting records on new cars but not requesting records on the disease malaria. The results from this frequently requested query are then stored in the cache. The third type of data is searches that are precompiled because otherwise they would take a long time to perform.

If the query is not in the cache, then the query is broadcast to a plurality of processors operating in parallel at block B1225. It should be noted that blocks B1225, B1230 and B1235 are in dashed lines because they are not requirements of the process in order to be operational, but rather are preferred embodiments that enhance the performance of the process. To be more specific, if the query is found in the cache, then blocks B1225-B1235 are eliminated and the overall time to provide the user with results is reduced. The use of parallel processors operating on either portions of the query or searching only portions of the inverted index also reduces the amount of time it takes to provide a result. Thus, a slower performing system that did not include a cache or parallel processors could also use the present process to generate results.

At block B 1230, the system receives the number of records that “hit” on the query provided in block B1205. At block B1235, the hits are compiled and the number of hits per category, as determined in block B 1215, is also compiled.

At block B 1240, the results are displayed to the user. Typically, these results are organized into categories. However, in a preferred embodiment, the system will display a default list of record hits when there are no sub-categories below the last category selected by the user. This prevents giving the user a listing of categories with 0 record hits because this information is not as useful to the user as to know which category the record hits are located in.

At block B1245, a determination is made based upon the results displayed. If the user is satisfied with the results, the process ends at block B 1250. If the user desires to refine the query or drill-down or drill-up further into the database, the process continues with a new query at block B1205.

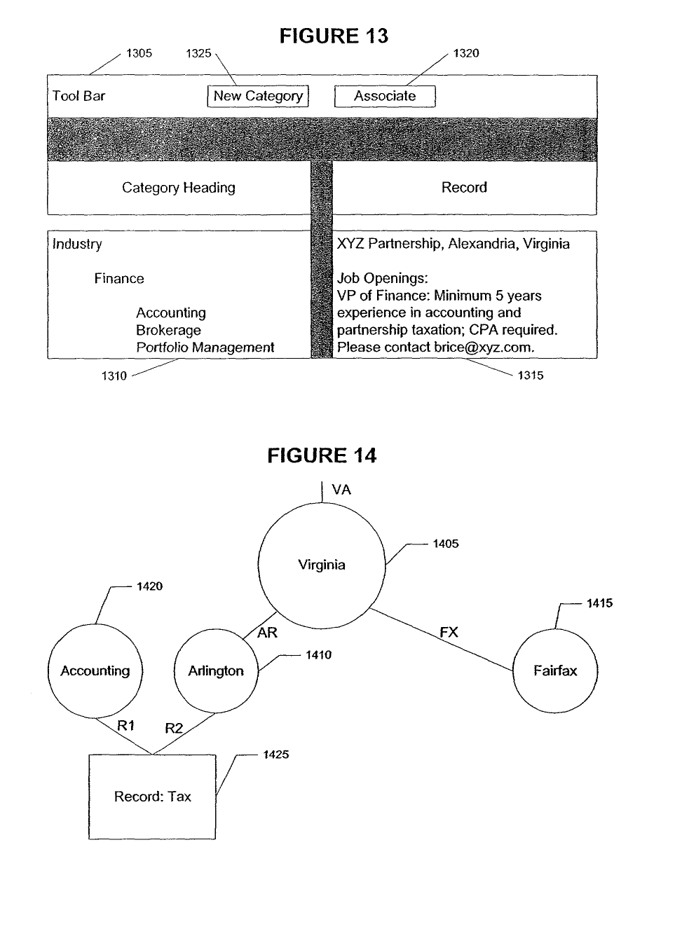

FIG. 13 is a screen shot of a categorizer in accordance with an embodiment of the present invention. This embodiment of a categorizer is a graphic user interface (GUI) that a system operator uses to assist in associating records with categories. Typically, the system operator uses this embodiment of the present invention to insert a new record into an existing category in the taxonomy. Section 1305 is a toolbar that provides such functionality as editing, searching within a record, changing the viewed record, printing, etc. Section 1310 is a graphic representation of the categories in the taxonomy. Section 1315 is a display of the current record.

The system operator scrolls through the taxonomy in section 1310 and the record in section 1315 looking for the best-fit categories for the record displayed in section 1315. When the system operator believes he/she has found a best-fit category for the displayed record, he/she instructs the system to make an association between the best-fit category and the displayed record by clicking button 1320.

In a preferred embodiment of the present invention, the record is scanned by the system before it is displayed. This scanning procedure compares the key terms stored in 710 with the word in the record. When a match is made, the record is highlighted so that the system operator may quickly discern which key terms are in that record. In addition, a count is performed on how many key terms are in this record. The system then queries the various category indices looking for a category title that matches the key term with the most hits in the record. Once that category is determined, that category is displayed along with its parent categories and its sub-categories so as to provide a frame of reference for the system operator. If the system operator agrees with the automatically determined category, he/she clicks on button 1320 to create an association between that determined category and the displayed record. If the system operator does not agree with suggested category and cannot find another suitable category by searching through the list of categories, he/she clicks on button 1325 to instruct the system to create a new category into the hierarchy.

The present invention is not limited to those embodiments described above. For example, the search terms entered by the user need not only be textual. The present invention also includes embodiments that can perform searches on dates, phone numbers, number ranges, proximity (i.e. Is X within 5 miles of Y?), field searches and Boolean searches. In addition, the present invention may be used with other types of queries such as natural language and context-sensitive queries.

Another embodiment of the present invention includes alternative queries placed into the cache. For example, before the first query is processed, precompiled queries such as those that are known to take a long time or are particularly timely, can be pre-loaded into the cache to save time.

The present invention is also not limited to two taxonomies. Any data collection can be represented by an unlimited number of independent taxonomies. Alternative embodiments are envisioned that include viewing data by job type, the salary, the required experience, if there are any special interests (i.e. CPA required) or any other identifiable category structure. Moreover, there is no theoretical limit to the depth of sub-categorization for each taxonomy.

The present invention is also not limited to when certain taxonomies are provided to the user. As described above, the user is presented with the taxonomy last selected. Thus, if the user is using the “Location” taxonomy and enters a new search term, the results will be displayed following the “Location” taxonomy described above. However, in an alternative embodiment, the system can switch among taxonomies automatically for the user in an effort to present the search results in a more meaningful manner. For example, if the user selects the final sub-category in the chain, the system will automatically switch over to another taxonomy so as to provide the user with more context and scope regarding the remaining search results. Thus, if there are no subcategories under “tires,” the present invention will switch to the “Location” taxonomy so that the user can easily determine where the tire salesmen are located. This switching can also be based on the number of hits. If the category contains only two hits, the system will automatically switch to the “Location” taxonomy and thereby provide the user with the useful information to locate these two tire salesmen. Similarly, the automatic taxonomy switching may also be based on a particular taxonomy where the number of categories or sub-categories is small. For instance, providing the user with the information that all the hit records are located in one category does not provide any information the user can use to distinguish between these records. Switching to another taxonomy may provide the user with more categories he/she can use to distinguish between the hit records.

It will be appreciated that one preferred embodiment of the present invention is system for searching a collection of employment and job data, said system comprising: an organizer configured to receive search requests, said organizer comprising: a collection of employment and job data having at least two entries; wherein the collection of employment and job data is organized into at least two taxonomies; wherein each of the at least two taxonomies is associated with at least two categories; wherein the entries correspond to at least one of the at least two taxonomies and also correspond to at least one of the at least two categories; and a search engine in communication with the collection of employment and job data, wherein said search engine is configured to search based on the at least two taxonomies and based on the at least two categories, wherein the search engine returns, in response to a search request identifying at least a first taxonomy of the at least two taxonomies, a list of the categories associated with the at least first identified taxonomy, along with the number of entries associated with each of the categories associated with the at least first identified taxonomy.

In a preferred embodiment of the present invention, the returned list of categories associated with the first taxonomy, along with the number of entries associated with each of the categories associated with the identified taxonomy can be further searched with regard to a second of the at least two taxonomies, whereby the search engine returns, in response to a search request identifying the second taxonomy of the at least two taxonomies, a list of the categories associated with both identified taxonomies, along with the number of entries associated with each of the categories associated with the second taxonomy.

In another preferred embodiment, the search engine, having returned, in response to a search request identifying a first taxonomy of the at least two taxonomies, a list of the categories associated with the identified taxonomy, along with the number of entries associated with each of the categories associated with the identified taxonomy, will provide only those categories with a non-zero number of entries associated with the identified taxonomy and will further return sub-categories both associated with the category and having a non-zero number of entries associated with the sub-category.

Still further in another preferred embodiment, the search engine, having further returned sub-categories both associated with the category and having a non-zero number of entries associated with the sub-category, will, in response to a search request identifying a second taxonomy of the at least two taxonomies, provide a list of the categories with a non-zero number of entries associated with the second identified taxonomy, along with the number of entries associated with each of the categories associated with the second identified taxonomy.

In another embodiment, the search engine, having returned, in response to a search request identifying a first taxonomy of the at least two taxonomies, a list of the categories associated with the identified taxonomy, along with the number of entries associated with each of the categories associated with the identified taxonomy, will, in response to a string query, provide those entries which both contain the string and are associated with the identified taxonomy. The string is preferably one member of the group consisting of text, image, and graphic.

The present invention can be either a network of computers or a single computer.

The present invention preferably comprises a cache which stores the returned results of the search engine for rapid retrieval.

There are many preferred taxonomies, including at least one taxonomy selected from the group consisting of product type, price, color, size, style, physical characteristics, delivery method, manufacturer, brand, components, ingredients, compatibility, warranty information, model year, age, and version.

In another preferred embodiment of the present invention, the present invention will, in response to a search request identifying one member selected from the group consisting of a taxonomy, a category, and a sub-category, the search engine additionally return an advertising entry. Preferably, the advertising entry is either a banner advertisement or a search-visible storefront.

Various preferred embodiments of the invention have been described in fulfillment of the various objects of the invention. It should be recognized that these embodiments are merely illustrative of the principles of the invention. Numerous modifications and adaptations thereof will be readily apparent to those skilled in the art without departing from the spirit and scope of the present invention.

1. A system for searching a collection of employment and job data, said system comprising:
an organizer configured to receive search requests, said organizer comprising:
a collection of employment and job data having at least two entries;
wherein the collection of employment and job data is organized into at least two taxonomies;
wherein each of the at least two taxonomies is associated with at least two categories;
wherein the entries correspond to at least one of the at least two taxonomies and also correspond to at least one of the at least two categories; and
a search engine in communication with the collection of employment and job data,
wherein said search engine is configured to search based on the at least two taxonomies and based on the at least two categories,
wherein the search engine returns, in response to a search request identifying at least a first taxonomy of the at least two taxonomies, a list of the categories associated with the at least first identified taxonomy, along with the number of entries associated with each of the categories associated with the at least first identified taxonomy.

2. The system according to claim 1, wherein the returned list of categories associated with the first taxonomy, along with the number of entries associated with each of the categories associated with the identified taxonomy can be further searched with regard to a second of the at least two taxonomies, whereby the search engine returns, in response to a search request identifying the second taxonomy of the at least two taxonomies, a list of the categories associated with both identified taxonomies, along with the number of entries associated with each of the categories associated with the second taxonomy.

3. The system according to claim 1, wherein the search engine, having returned, in response to a search request identifying a first taxonomy of the at least two taxonomies, a list of the categories associated with the identified taxonomy, along with the number of entries associated with each of the categories associated with the identified taxonomy, will provide only those categories with a non-zero number of entries associated with the identified taxonomy and will further return sub-categories both associated with the category and having a non-zero number of entries associated with the sub-category.

4. The system according to claim 3, wherein the search engine, having further returned sub-categories both associated with the category and having a non-zero number of entries associated with the sub-category, will, in response to a search request identifying a second taxonomy of the at least two taxonomies, provide a list of the categories with a non-zero number of entries associated with the second identified taxonomy, along with the number of entries associated with each of the categories associated with the second identified taxonomy.

5. The system according to claim 1, wherein the search engine, having returned, in response to a search request identifying a first taxonomy of the at least two taxonomies, a list of the categories associated with the identified taxonomy, along with the number of entries associated with each of the categories associated with the identified taxonomy, will, in response to a string query, provide those entries which both contain the string and are associated with the identified taxonomy.

6. The system according to claim 5, wherein the string is one member of the group consisting of text, image, and graphic.

7. The system according to claim 1, wherein the system comprises a network of computers.

8. The system according to claim 1, wherein the system comprises a single computer.

9. The system according to claim 1, wherein the system further comprises a cache which stores the returned results of the search engine for rapid retrieval.

10. The system for searching a collection of employment and job data according to claim 1, wherein at least one taxonomy of the at least two taxonomies is selected from the group consisting of company, industry, job type, location, salary, experience, certifications, benefits, education, minimum performance requirements, and incentives.

11. The system for searching a collection of employment and job data according to claim 1, wherein, in response to a search request identifying one member selected from the group consisting of a taxonomy, a category, and a sub-category, the search engine additionally returns an advertising entry.

12. The system for searching a collection of employment and job data according to claim 17, wherein the advertising entry is at least one member selected from the group consisting of a banner advertisement and a search-visible storefront.

13. A system for searching a collection of employment and job data, said system comprising:
means for networking a plurality of computers; and
means for organizing executing in said computer network and configured to receive search requests from any one of said plurality of computers, said means for organizing comprising:
a collection of employment and job data having at least two entries;
wherein the collection of employment and job data is organized into at least two taxonomies;
wherein each of the at least two taxonomies is associated with at least two categories;
wherein the entries correspond to at least one of the at least two taxonomies and also correspond to at least one of the at least two categories; and
means for searching in communication with the collection of employment and job data,
wherein said means for searching is configured to search based on the at least two taxonomies and based on the at least two categories,
wherein the means for searching returns, in response to a search request identifying one of the at least two taxonomies, a list of the categories associated with the identified taxonomy, along with the number of entries associated with each of the categories associated with the identified taxonomy.

14. The system according to claim 13, wherein the returned list of categories associated with the first taxonomy, along with the number of entries associated with each of the categories associated with the identified taxonomy can be further searched with regard to a second of the at least two taxonomies, whereby the means for searching returns, in response to a search request identifying the second taxonomy of the at least two taxonomies, a list of the categories associated with both identified taxonomies, along with the number of entries associated with each of the categories associated with the second taxonomy.

15. The system for searching a collection of employment and job data according to claim 13, wherein the means for searching, having returned, in response to a search request identifying a first taxonomy of the at least two taxonomies, a list of the categories associated with the identified taxonomy, along with the number of entries associated with each of the categories associated with the identified taxonomy, will provide only those categories with a non-zero number of entries associated with the identified taxonomy and will further provide sub-categories associated with the category and having a non-zero number of entries associated with the sub-category.

16. The system for searching a collection of employment and job data according to claim 15, wherein the means for searching, having further returned sub-categories both associated with the category and having a non-zero number of entries associated with the sub-category, will, in response to a search request identifying a second taxonomy of the at least two taxonomies, provide a list of the categories with a non-zero number of entries associated with the second identified taxonomy, along with the number of entries associated with each of the categories associated with the second identified taxonomy.

17. The system for searching a collection of employment and job data according to claim 15, wherein the means for searching, having returned, in response to a search request identifying a first taxonomy of the at least two taxonomies, a list of the categories associated with the identified taxonomy, along with the number of entries associated with each of the categories associated with the identified taxonomy, will, in response to a string query, provide those entries which both contain the string and are associated with the identified taxonomy.

18. The system for searching a collection of employment and job data according to claim 17, wherein the string is one member of the group consisting of text, image, and graphic.

19. The system for searching a collection of employment and job data according to claim 15, wherein the system comprises a network of computers.

20. The system for searching a collection of employment and job data according to claim 15, wherein the system comprises a single computer.

21. The system for searching a collection of employment and job data according to claim 15, wherein the system further comprises a cache which stores the returned results of the means for searching for rapid retrieval.

22. The system for searching a collection of employment and job data according to claim 15, wherein at least one taxonomy of the at least two taxonomies is selected from the group consisting of company, industry, job type, location, salary, experience, certifications, benefits, education, minimum performance requirements, and incentives.

23. The system for searching a collection of employment and job data according to claim 15, wherein, in response to a search request identifying one member selected from the group consisting of a taxonomy, a category, and a sub-category, the means for searching additionally returns an advertising entry.

24. The system for searching a collection of employment and job data according to claim 23, wherein the advertising entry is at least one member selected from the group consisting of a banner advertisement and a search-visible storefront.

25. A method for searching a collection of employment and job data, said method comprising:
communicating a search request to a search engine, the search engine being in communication with a collection of employment and job data;
wherein the collection of employment and job data has at least two entries;
wherein the collection of employment and job data is organized into at least two taxonomies;
wherein each of the at least two taxonomies is associated with at least two categories;
wherein the at least two entries correspond to at least one of the at least two taxonomies and also correspond to at least one of the at least two categories;
querying of the collection of employment and job data by the search engine based on the communicated search request;
wherein the communicated search request identifies at least one of the at least two taxonomies;
returning of a list of the categories associated with the at least one identified taxonomy, along with the number of entries associated with each of the categories associated with the at least one identified taxonomy as a response to the querying of the collection of employment and job data.

26. The method for searching a collection of employment and job data according to claim 25, wherein the method further comprises
returning, in response to a search request identifying a second taxonomy of the at least two taxonomies, a list of the categories associated with both identified taxonomies, along with the number of entries associated with each of the categories associated with the second taxonomy.

27. The method for searching a collection of employment and job data according to claim 25, wherein the method further comprises
returning a list of only those categories with a non-zero number of entries associated with the identified taxonomy and further returning at least one sub-category associated with the category and having a non-zero number of entries associated with the sub-category.

28. The method for searching a collection of employment and job data according to claim 27, wherein the method further comprises
having further returned sub-categories both associated with the category and having a non-zero number of entries associated with the sub-category, providing, in response to a search request identifying a second taxonomy of the at least two taxonomies, provide a list of the categories with a non-zero number of entries associated with the second identified taxonomy, along with the number of entries associated with each of the categories associated with the second identified taxonomy.

29. The method for searching a collection of employment and job data according to claim 25, wherein the method further comprises
returning, in response to a string query, provide those entries which both contain the string and are associated with the identified taxonomy.

30. The method for searching a collection of employment and job data according to claim 29, wherein the string is one member of the group consisting of text, image, and graphic.

31. The method for searching a collection of employment and job data according to claim 25, wherein the system comprises a network of computers.

32. The method for searching a collection of employment and job data according to claim 25, wherein the system comprises a single computer.

33. The method for searching a collection of employment and job data according to claim 25, wherein the system further comprises a cache which stores the returned results of the means for searching for rapid retrieval.

34. The method for searching a collection of employment and job data according to claim 25, wherein at least one taxonomy of the at least two taxonomies is selected from the group consisting of company, industry, job type, location, salary, experience, certifications, benefits, education, minimum performance requirements, and incentives.

35. The method for searching a collection of employment and job data according to claim 25, wherein the method further comprises
returning by the search engine additionally, in response to a search request identifying one member selected from the group consisting of a taxonomy, a category, and a sub-category, an advertising entry.

36. The method for searching a collection of employment and job data according to claim 35, wherein the advertising entry is at least one member selected from the group consisting of a banner advertisement and a search-visible storefront.

37. An article of manufacture comprising:
a computer usable medium having computer program code means embodied thereon for searching a collection of employment and job data, the computer readable program code means in said article of manufacture comprising:
computer readable program code means for communicating a search request to a search engine, the search engine being in communication with a collection of employment and job data;
wherein the collection of employment and job data has at least two entries;
wherein the collection of employment and job data is organized into at least two taxonomies;
wherein each of the at least two taxonomies is associated with at least two categories;
wherein the at least two entries correspond to at least one of the at least two taxonomies and also correspond to at least one of the at least two categories;
computer readable program code means for querying of the collection of employment and job data by the search engine based on the communicated search request;
wherein a communicated search request identifies at least one of the at least two taxonomies; and
computer readable program code means for returning of a list of the categories associated with the at least one identified taxonomy, along with the number of entries associated with each of the categories associated with the at least one identified taxonomy as a response to the querying of the collection of employment and job data.

38. The article of manufacture according to claim 37, wherein the returned list of categories associated with the first taxonomy, along with the number of entries associated with each of the categories associated with the identified taxonomy can be further searched with regard to a second of the at least two taxonomies, whereby the computer readable program code means for querying of the collection of employment and job data by the search engine returns, in response to a search request identifying the second taxonomy of the at least two taxonomies, a list of the categories associated with both identified taxonomies, along with the number of entries associated with each of the categories associated with the second taxonomy.

39. The article of manufacture according to claim 37, wherein the computer readable program code means for querying of the collection of employment and job data by the search engine, having returned, in response to a search request identifying a first taxonomy of the at least two taxonomies, a list of the categories associated with the identified taxonomy, along with the number of entries associated with each of the categories associated with the identified taxonomy, will provide only those categories with a non-zero number of entries associated with the identified taxonomy and will further provide sub-categories associated with the category and having a non-zero number of entries associated with the sub-category.

40. The article of manufacture according to claim 39, wherein the computer readable program code means for querying of the collection of employment and job data by the search engine, having further returned sub-categories both associated with the category and having a non-zero number of entries associated with the sub-category, will, in response to a search request identifying a second taxonomy of the at least two taxonomies, provide a list of the categories with a non-zero number of entries associated with the second identified taxonomy, along with the number of entries associated with each of the categories associated with the second identified taxonomy.

41. The article of manufacture according to claim 37, wherein the means for searching, having returned, in response to a search request identifying a first taxonomy of the at least two taxonomies, a list of the categories associated with the identified taxonomy, along with the number of entries associated with each of the categories associated with the identified taxonomy, will, in response to a string query, provide those entries which both contain the string and are associated with the identified taxonomy.

42. The article of manufacture according to claim 41, wherein the string is one member of the group consisting of text, image, and graphic.

43. The article of manufacture according to claim 37, wherein at least one taxonomy of the at least two taxonomies is selected from the group consisting of company, industry, job type, location, salary, experience, certifications, benefits, education, minimum performance requirements, and incentives.

44. The article of manufacture according to claim 37, wherein, in response to a search request identifying one member selected from the group consisting of a taxonomy, a category, and a sub-category, the search engine additionally returns an advertising entry.

45. The article of manufacture according to claim 44, wherein the advertising entry is at least one member selected from the group consisting of a banner advertisement and a search-visible storefront.
